(19) United States
(12) Patent Application Publication
(10) Pub. No.: US 2008/0313005 A1
(43) Pub. Date: Dec. 18, 2008

(54) SYSTEM AND METHOD FOR REAL-TIME SCHEDULING OF HUMAN AND NON-HUMAN RESOURCES

(75) Inventors: Kevin S. Nessland, Bozeman, MT (US); Jerome L. Nettuno, Bozeman, MT (US)

Correspondence Address: ANTOINETTE M. TEASE, P. O. BOX 51016, BILLINGS, MT, 59105, US

(73) Assignee: Edgelnova International, Inc., Bozeman, MT (US)

(21) Appl. No.: 11/764,178

(22) Filed: Jun. 15, 2007

(51) Int. Cl. G06Q 10/00; G06F 17/30; G06F 17/40

(52) U.S. Cl. 705/9; 705/8

(57) ABSTRACT

A system for real-time resource scheduling comprising a hosted line-of-business software application for service providers operating in various industry verticals; a central data center; an in-store web-based calendar for service provider employees; a web-based calendar for service provider customers; and a mobile customer scheduling interface; wherein the central data center comprises a data store that comprises a master database and a plurality of service provider chain databases; the master database contains metadata of all service provider chain databases housed in the data store; the master database contains user accounts for customers who make reservations with any of the service providers; each service provider has a service provider chain database that is specific to that service provider; each service provider creates and maintains all resource scheduling information for its own human and non-human resources; and no data is shared between service providers.

### BACKGROUND OF THE INVENTION

1. Field of the Invention

The present invention relates generally to the field of computer-implemented inventions, and more specifically to a system and method for scheduling human and/or non-human resources that provides real-time customer access to a plurality of service provider calendars via various electronic scheduling interfaces.

2. Description of the Related Art

Businesses that provide services or rent physical resources to their customers must pay close attention to resource scheduling and utilization. Tracking which human resources are available to provide which services; knowing which physical resources are currently in use; notifying staff of upcoming appointments; quickly answering customer inquiries about resource availability: these tasks are a common challenge to all service-oriented businesses, and a major portion of each work day is spent monitoring resource schedules and responding to customer requests for appointments. Often, one or more employees are dedicated to nothing more than taking appointments and ensuring resources are in the right place at the right time. In sole proprietor shops, these activities have a direct impact on the bottom line as time spent booking appointments is time lost delivering services—and earning revenue.

To address this problem, the marketplace has responded with information technology solutions to help track and schedule both human and non-human resources. Prior art describes several resource-scheduling software applications that are intended to aid the service provider with setting schedules, booking appointments, and monitoring current utilization of resources. While these innovations are indeed valuable and widely used, the problem remains that one or more employees must still monitor and update this ‘electronic planner,’ referring to it each time a customer calls for an appointment and updating it often to reflect new and cancelled appointments.

The dawning of the Internet age opened up new possibilities to increase efficiencies in the service provider industry. Prior art describes the work of innovators who immediately saw the potential in providing customer access to a service provider's scheduling information via the Internet. The thought, of course, is that if a customer can handle the business of reviewing a schedule and booking an appointment herself, the service provider is freed up to deliver the goods and services that are the lifeblood of its business.

The execution of this vision, however, has been problematic. First, there is the issue of a service provider letting its customers know that they have the option of scheduling appointments without calling or walking into the shop. While customer adoption of Internet technology has increased significantly since its introduction, so too has the number of web sites and Internet-based applications. A service provider telling its customers to visit a web URL to schedule upcoming appointments is easily lost in the cacophony of advertising and media reports of the hottest, latest web destinations. Additionally, considering the number of service providers with which a typical individual interacts on a regular basis (esthetician, hair stylist, mechanic, personal trainer, etc.), it is not long before a smattering of web sites to make life easier becomes a deluge of user names and passwords that must be recalled with each attempt to schedule online.

One answer to the problem of the standalone service provider resource scheduling web site has been aggregate resource scheduling software systems, described in prior art as public network (typically World Wide Web) destinations that provide a single interface to the scheduling calendars of a plurality of service providers. This approach has obvious advantages for the customer, providing a one-stop shop that is easily bookmarked by regular visitors for use over and over again and easily remembered by new visitors who might happen upon the URL in advertising, conversation with friends and acquaintances, or interaction with their favorite service providers whose schedules are available on the site. These sites often require the customer to remember only a single user name and password that can be used to schedule appointments with a plurality of service providers.

Unfortunately, the technical implementation of an aggregate resource scheduling software system is not without its difficulties. Such systems typically employ one of two architectural models—distributed systems that use data replication to pull data from disparate scheduling systems to create a single appointment scheduling database, or centralized systems with a single database that is used by both customers and disparate service providers for all scheduling.

In systems that use a distributed architecture, the aggregate resource scheduling software typically allows the customer to review scheduling information and create an appointment using data available in a central database. These systems face the complex problem of synchronizing data that is updated centrally with that updated locally by the service providers in their separate, standalone resource scheduling applications. To avoid “double-booking” (scheduling the same service or resource twice in the same time slot in separate software systems) distributed systems using this architecture must either frequently replicate data bi-directionally or set new appointments made using the aggregate resource scheduling interface to a status of ‘pending’ while the service provider makes a manual decision to accept or reject the appointment. If the resource scheduling software uses data replication as the solution to this problem, information must be forwarded to the centralized database as appointments are made in the separate service provider scheduling applications so that customers querying the central database for open time slots receive accurate information. Likewise, as appointments are scheduled centrally, that data must be sent back to the service provider database to both notify the service provider of the new appointments and avoid double-booking in the service provider's scheduling software.

The replication of data is not as simple as it sounds. Even with very frequent replication, the possibility exists that a time slot may have been double-booked in the separate software systems between replication events. Conflicts are inevitable, and software systems that share data in this manner must possess business logic that allows system users to review these conflicts and determine which appointment should be retained and which should be discarded. A discarded appointment requires communication with the losing customer to inform him or her that an appointment must be rescheduled.

Aggregate resource scheduling software systems that use ‘decisioning’ to deal with double-booking—ie., they set all new appointments to a status of ‘pending’ until the appointment is accepted or rejected by someone who has access to the service provider's authoritative schedule—are simple to implement technically, but lack the immediate feedback desired by customers and do little to lessen the manual workload of maintaining an ‘electronic planner’ in the service provider's shop.

To address these weaknesses in distributed system architectures, prior art describes aggregate resource scheduling software where the centralized system is made the single, authoritative source for all scheduled appointments: both customers and service providers must schedule all appointments only in the centralized scheduling application. While this model certainly solves the technical problems of data concurrency and synchronization, it is problematic because it forces service providers to abandon whatever resource scheduling software they may have been using formerly as a condition of joining the aggregate resource scheduling community. Service providers may be reticent to take this step if their existing resource scheduling software is highly functional or tightly integrated with their overall enterprise business management software. The end result is either lower participation in the scheduling community—diminishing its effectiveness for customers seeking to schedule appointments for services and resources made available by service providers—or reduced efficiency for the service provider who must either give up the functionality of a tightly-integrated scheduling solution for one that is removed from the line-of-business application used to run the business day-to-day or resort to double-entry of schedule information in the two disparate systems. Service providers may also be concerned that by becoming a part of the scheduling community, they have given up a perceived branding opportunity and become just another name in a list of competing service providers.

A final issue with aggregate resource scheduling systems that provide customer access to a plurality of service provider calendars is that they have historically assumed that the main customer method for interaction with the system will be the web browser. Consequently, as new consumer technologies become available (such as smart phones that are capable of running software applications), these HTML-based systems cannot be modified quickly for delivery of scheduling information to the new electronic scheduling interfaces. If a service provider determines that allowing customers to schedule appointments using these new electronic scheduling interfaces is compelling, they are left with few choices other than adopting yet another scheduling system that may or may not integrate with the one they are already using. This spawning of non-integrated, disparate systems forces the service provider to track scheduling information in several different applications, actually creating additional work and compounding the very problems resource scheduling software applications were intended to solve.

What is needed is an aggregate resource scheduling system that provides a single location where customers can book reservations with a plurality of service providers but that avoids issues of data concurrency, that provides real-time, authoritative information to customers who are scheduling appointments and does not require such requests to enter ‘pending’ status until approved or denied, and that offers service providers integration with line-of-business applications to provide a compelling business proposition for participation in the scheduling community. Further, this centralized solution should provide completely autonomous data stores to preserve separation between the plurality of service providers who may be providing competitive goods and services. Further still, this solution should support the rapid development of new customer scheduling interfaces to allow service providers to quickly harness new customer technologies using their existing technology infrastructure and investment.

### BRIEF SUMMARY OF THE INVENTION

The present invention is a system for real-time resource scheduling comprising: a hosted line-of-business software application for service providers operating in various industry verticals; a central data center; an in-store web-based calendar for service provider employees; a web-based calendar for service provider customers; and a mobile customer scheduling interface; wherein the central data center comprises a data store; wherein the data store comprises a master database and a plurality of service provider chain databases; wherein the master database contains metadata of all service provider chain databases housed in the data store; wherein the master database contains user accounts for customers who make reservations with any of the service providers; wherein each service provider has a service provider chain database that is specific to that service provider; wherein customer profile information is stored in the service provider chain databases; wherein a customer's user account is associated with customer profile data for that customer in multiple, autonomous service provider chain databases; wherein no data is shared between service providers; wherein each service provider creates and maintains all resource scheduling information for its own human and non-human resources; wherein the resource scheduling information comprises availability information; wherein a customer uses either the web-based customer calendar or the mobile scheduling interface to make a reservation for a resource; wherein when the customer accesses the web-based calendar or the mobile scheduling interface to make a reservation, only the time slots for which the resource is available are made available to the customer for a new reservation; wherein a service provider employee uses the web-based in-store calendar to make a reservation for a resource on behalf of a customer; wherein when a reservation is made by a customer or a service provider employee, the reservation information is transmitted in real-time to the service provider chain database; and wherein instances of the web-based in-store calendar and the web-based customer calendar poll at configurable intervals for updates to reservation information and are updated with new reservation information during each subsequent polling cycle. Preferably, the configurable interval is several seconds.

In a preferred embodiment, the web-based customer calendar shows resources only for a single service provider. Preferably, the web-based customer calendar displays existing reservations in a different color to signify that one or more time slots are not available for scheduling. Preferably, the web-based in-store calendar displays existing reservations in a different color to signify that one or more time slots are not available for scheduling.

In a preferred embodiment, the service provider chain database comprises a customer table, and when a customer signs in using an existing user account or creates a new user account, the system inserts a new record in the customer table of the service provider chain database if this is the first time the customer has signed in to a location in that service provider's network of locations. Preferably, each service provider chain database contains data specific to a particular service provider or chain of related service providers. Preferably, the data specific to a particular service provider or chain of related service providers comprises inventory records, service records, membership/package records, sales history, purchase orders, client/customer profiles, email and text messages sent for purposes of marketing or reminding customers of upcoming reservations, and/or employee user accounts. Preferably, the data specific to a particular service provider or chain of related service providers comprises data required for scheduling reservations of human and non-human resources, and the data required for scheduling reservations of human and non-human resources comprises human resource records, resource records for non-human resources that can be reserved by customers, resource groups that organize resources for presentation in various scheduling interfaces, availability periods that define days and hours a particular resource is available for reservation, and/or reservation records.

In a preferred embodiment, the data center further comprises an HTTP web server, wherein the HTTP web server receives reservation instructions from customers using the web-based customer calendar or the mobile scheduling interface or from employees using the web-based in-store calendar; wherein the received instructions have a payload; wherein the HTTP web server brokers the payload of the received instructions to XML Web Services; wherein the XML Web Services invoke SQL stored procedures to get data from and put data to the data store; wherein XML Web Services format and send data back to the HTTP server; and wherein the HTTP server packages the formatted data and sends it back to the customer or employee requesting the reservation. Preferably, the instructions are in the form of Simple Object Access Protocol messages.

In a preferred embodiment, the hosted line-of-business software application comprises a web-based service management form, and a service provider employee uses the service management form to define services to be offered by that service provider's human resources. Preferably, the service management form comprises a means for specifying a status of active or inactive for a particular service record, a field for specifying the average duration of the service, and/or a field for recording a description of the service, and a save button to commit any changes made to the service record to the service provider chain database. The duration of the service specified in the service management form preferably determines the amount of time a reservation for that service will block out on the web-based in-store calendar and the web-based customer calendar.

In a preferred embodiment, the hosted line-of-business software application comprises web-based human and non-human resource management forms. Preferably, the human resource management form comprises a sub-tab that allows a human resource record to be associated with one or more services defined in the service management form.

In a preferred embodiment, the hosted line-of-business software application comprises a calendar management form, and the calendar management form comprises a list of resources to be presented to individuals who are making reservations with human and non-human resources using the web-based in-store calendar or the web-based customer calendar. Preferably, the calendar management form allows for the creation of resource groups for organizing the list of resources to be presented to individuals who are making reservations. Preferably, the calendar management form comprises a slot length field that allows a service provider to specify schedulable intervals that will appear on the web-based in-store calendar and the web-based customer calendar. Preferably, the calendar management form comprises a default reservation duration field that allows a service provider to specify a default length of a reservation for a non-human resource.

In a preferred embodiment, a service provider uses the hosted line-of-business application to configure services and resources to be offered by that service provider and to organize the resources into groups. Preferably, the hosted line-of-business software application is web-based software that comprises point of sale, inventory management, reporting, customer marketing, and payroll functionality.

In a preferred embodiment, a customer-created reservation is insured to be valid by pre-qualifying available reservation options and presenting them in real-time to the customer. Preferably, resource availability data is presented to the service provider employee via the web-based in-store calendar and to the customer via the web-based customer calendar and/or the mobile scheduling interface, and both the employee and the customer are presented with the same resource availability data in real-time, thereby eliminating double-booking and delayed notification of reservation acceptance or denial.

In a preferred embodiment, the web-based customer calendar is specific to a service provider or service provider location. Preferably, the web-based in-store calendar shows a schedule for all resources in a resource group. Preferably, service provider employees use the web-based in-store calendar to define availability periods for each resource for which a reservation may be made.

In a preferred embodiment, the in-store calendar comprises functionality for searching for customer records and specifying reservation details. Preferably, after a service provider employee saves a reservation in the web-based in-store calendar, the service provider chain database is updated in real-time with information about the reservation.

In a preferred embodiment, the web-based customer calendar shows a daily schedule for all resources in a resource group selected from a drop-down list of resource groups. Preferably, the web-based customer calendar displays a weekly schedule for a selected resource. In an alternate embodiment, the web-based customer calendar displays a weekly schedule for all resources in a selected resource group. In an alternate embodiment, the web-based customer calendar displays a monthly schedule for a selected resource.

In a preferred embodiment, to make a reservation a customer selects an empty time slot in a pre-defined availability period. Preferably, after a customer saves a reservation in the web-based customer calendar, the service provider chain database is updated in real-time with information about the reservation. Preferably, when the customer or service provider employee selects a start time for a new reservation, the services offered by the selected human resource are filtered based on the start time selected by the customer or employee, the availability information for the resource, and if there is a subsequent reservation with a start time, the start time of the subsequent reservation for the resource.

In a preferred embodiment, the mobile scheduling interface allows customers to select from a plurality of service providers to make a resource reservation. Preferably, the mobile scheduling interface provides the ability to search for service providers by zip code, global positioning system coordinates, city, county, area code, and/or service provider category.

In a preferred embodiment, the mobile scheduling interface comprises a mobile scheduling wizard, and the mobile scheduling wizard comprises a list of service providers with which the customer has previously made reservations. Preferably, when a customer selects a service provider, information concerning the selection is sent to an XML Web Service and date information is requested, and the requested date information is displayed on a subsequent page of the mobile scheduling wizard. Preferably, the mobile scheduling wizard displays a list of dates on which the selected service provider is willing to accept reservations self-scheduled by customers, and the customer selects a date for a new reservation. Preferably, the mobile scheduling wizard displays a list of resource groups defined by the selected service provider and available on the date selected by the customer, and the customer selects a resource group.

In a preferred embodiment, the mobile scheduling wizard displays a list of resources within the resource group selected by the customer, and the customer selects a resource. Preferably, if the selected resource is a human resource, the mobile scheduling wizard displays a list of services associated with the selected human resource, and the customer selects a service. Preferably, the mobile scheduling wizard displays a list of dates and times that are currently available for reservation based on the selections previously made by the customer. Preferably, when the customer selects a date and time for a new reservation, the reservation is booked, and the service provider chain database is updated in real-time with information about the new reservation.

In a preferred embodiment, no distinction is made between reservations made by a customer and reservations made by a service provider employee. Preferably, the system concurrently provides stand-alone and aggregate resource scheduling functionality.

The present invention further comprises a method for real-time resource scheduling comprising: providing a hosted line-of-business software application for service providers operating in various industry verticals; providing a central data center; providing an in-store web-based calendar for service provider employees; providing a web-based calendar for service provider customers; and providing a mobile customer scheduling interface; wherein the central data center comprises a data store; wherein the data store comprises a master database and a plurality of service provider chain databases; wherein the master database contains metadata of all service provider chain databases housed in the data store; wherein the master database contains user accounts for customers who make reservations with any of the service providers; wherein each service provider has a service provider chain database that is specific to that service provider; wherein customer profile information is stored in the service provider chain databases; herein a customer's user account is associated with customer profile data for that customer in multiple, autonomous service provider chain databases; herein no data is shared between service providers; wherein each service provider creates and maintains all resource scheduling information for its own human and non-human resources; wherein the resource scheduling information comprises availability information; herein a customer uses either the web-based customer calendar or the mobile scheduling interface to make a reservation for a resource; herein when the customer accesses the web-based calendar or the mobile scheduling interface to make a reservation, only the time slots for which the resource is available are made available to the customer for a new reservation; herein a service provider employee uses the web-based in-store calendar to make a reservation for a resource on behalf of a customer; herein when a reservation is made by a customer or a service provider employee, the reservation information is transmitted in real-time to the service provider chain database; and wherein instances of the web-based in-store calendar and the web-based customer calendar poll at configurable intervals for updates to reservation information and are updated with new reservation information during each subsequent polling cycle. Preferably, the configurable interval is several seconds.

In a preferred embodiment, the web-based customer calendar shows resources only for a single service provider. Preferably, the web-based customer calendar displays existing reservations in a different color to signify that one or more time slots are not available for scheduling. Preferably, the web-based in-store calendar displays existing reservations in a different color to signify that one or more time slots are not available for scheduling.

In a preferred embodiment, the service provider chain database comprises a customer table, and when a customer signs in using an existing user account or creates a new user account, the system inserts a new record in the customer table of the service provider chain database if this is the first time the customer has signed in to a location in that service provider's network of locations. Preferably, each service provider chain database contains data specific to a particular service provider or chain of related service providers. Preferably, the data specific to a particular service provider or chain of related service providers comprises inventory records, service records, membership/package records, sales history, purchase orders, client/customer profiles, email and text messages sent for purposes of marketing or reminding customers of upcoming reservations, and/or employee user accounts. Preferably, the data specific to a particular service provider or chain of related service providers comprises data required for scheduling reservations of human and non-human resources, and the data required for scheduling reservations of human and non-human resources comprises human resource records, resource records for non-human resources that can be reserved by customers, resource groups that organize resources for presentation in various scheduling interfaces, availability periods that define days and hours a particular resource is available for reservation, and/or reservation records.

In a preferred embodiment, the data center further comprises an HTTP web server, wherein the HTTP web server receives reservation instructions from customers using the web-based customer calendar or the mobile scheduling interface or from employees using the web-based in-store calendar; wherein the received instructions have a payload; wherein the HTTP web server brokers the payload of the received instructions to XML Web Services; wherein the XML Web Services invoke SQL stored procedures to get data from and put data to the data store; wherein XML Web Services format and send data back to the HTTP server; and wherein the HTTP server packages the formatted data and sends it back to the customer or employee requesting the reservation. Preferably, the instructions are in the form of Simple Object Access Protocol messages.

In a preferred embodiment, the hosted line-of-business software application comprises a web-based service management form, and wherein a service provider employee uses the service management form to define services to be offered by that service provider's human resources. Preferably, the service management form comprises a means for specifying a status of active or inactive for a particular service record, a field for specifying the average duration of the service, and/or a field for recording a description of the service, and a save button to commit any changes made to the service record to the service provider chain database. The duration of the service specified in the service management form preferably determines the amount of time a reservation for that service will block out on the web-based in-store calendar and the web-based customer calendar.

In a preferred embodiment, the hosted line-of-business software application comprises web-based human and non-human resource management forms. Preferably, the human resource management form comprises a sub-tab that allows a human resource record to be associated with one or more services defined in the service management form.

In a preferred embodiment, the hosted line-of-business software application comprises a calendar management form, and the calendar management form comprises a list of resources to be presented to individuals who are making reservations with human and non-human resources using the web-based in-store calendar or the web-based customer calendar. Preferably, the calendar management form allows for the creation of resource groups for organizing the list of resources to be presented to individuals who are making reservations. Preferably, the calendar management form comprises a slot length field that allows a service provider to specify schedulable intervals that will appear on the web-based in-store calendar and the web-based customer calendar. Preferably, the calendar management form comprises a default reservation duration field that allows a service provider to specify a default length of a reservation for a non-human resource.

In a preferred embodiment, a service provider uses the hosted line-of-business application to configure services and resources to be offered by that service provider and to organize the resources into groups. Preferably, the hosted line-of-business software application is web-based software that comprises point of sale, inventory management, reporting, customer marketing, and payroll functionality.

In a preferred embodiment, a customer-created reservation is insured to be valid by pre-qualifying available reservation options and presenting them in real-time to the customer. Preferably, resource availability data is presented to the service provider employee via the web-based in-store calendar and to the customer via the web-based customer calendar and/or the mobile scheduling interface, and both the employee and the customer are presented with the same resource availability data in real-time, thereby eliminating double-booking and delayed notification of reservation acceptance or denial.

In a preferred embodiment, the web-based customer calendar is specific to a service provider or service provider location. Preferably, the web-based in-store calendar shows a schedule for all resources in a resource group. Preferably, service provider employees use the web-based in-store calendar to define availability periods for each resource for which a reservation may be made.

In a preferred embodiment, the in-store calendar comprises functionality for searching for customer records and specifying reservation details. Preferably, after a service provider employee saves a reservation in the web-based in-store calendar, the service provider chain database is updated in real-time with information about the reservation.

In a preferred embodiment, the web-based customer calendar shows a daily schedule for all resources in a resource group selected from a drop-down list of resource groups. Preferably, the web-based customer calendar displays a weekly schedule for a selected resource. In an alternate embodiment, the web-based customer calendar displays a weekly schedule for all resources in a selected resource group. In an alternate embodiment, the web-based customer calendar displays a monthly schedule for a selected resource.

In a preferred embodiment, to make a reservation a customer selects an empty time slot in a pre-defined availability period. Preferably, after a customer saves a reservation in the web-based customer calendar, the service provider chain database is updated in real-time with information about the reservation. Preferably, when the customer or service provider employee selects a start time for a new reservation, the services offered by the selected human resource are filtered based on the start time selected by the customer or employee, the availability information for the resource, and if there is a subsequent reservation with a start time, the start time of the subsequent reservation for the resource.

In a preferred embodiment, the mobile scheduling interface allows customers to select from a plurality of service providers to make a resource reservation. Preferably, the mobile scheduling interface provides the ability to search for service providers by zip code, global positioning system coordinates, city, county, area code, and/or service provider category.

In a preferred embodiment the mobile scheduling interface comprises a mobile scheduling wizard, and the mobile scheduling wizard comprises a list of service providers with which the customer has previously made reservations. Preferably, when a customer selects a service provider, information concerning the selection is sent to an XML Web Service and date information is requested, and the requested date information is displayed on a subsequent page of the mobile scheduling wizard. Preferably, the mobile scheduling wizard displays a list of dates on which the selected service provider is willing to accept reservations self-scheduled by customers, and the customer selects a date for a new reservation. Preferably, the mobile scheduling wizard displays a list of resource groups defined by the selected service provider and available on the date selected by the customer, and wherein the customer selects a resource group.

In a preferred embodiment, the mobile scheduling wizard displays a list of resources within the resource group selected by the customer, and the customer selects a resource. Preferably, if the selected resource is a human resource, the mobile scheduling wizard displays a list of services associated with the selected human resource, and the customer selects a service. Preferably, the mobile scheduling wizard displays a list of dates and times that are currently available for reservation based on the selections previously made by the customer. Preferably, when the customer selects a date and time for a new reservation, the reservation is booked, and the service provider chain database is updated in real-time with information about the new reservation.

In a preferred embodiment, no distinction is made between reservations made by a customer and reservations made by a service provider employee. Preferably, the system concurrently provides stand-alone and aggregate resource scheduling functionality.

### BRIEF DESCRIPTION OF THE DRAWINGS

FIG. 1 is a diagram of the network architecture of a preferred embodiment of the present invention.

FIG. 2 is a diagram of the software architecture of a preferred embodiment of the present invention.

FIG. 3 is a diagram of the data store of a preferred embodiment of the present invention.

FIG. 4 is a screen shot of a web-based service management form made available in a preferred embodiment of the line-of-business application of the present invention.

FIG. 5 is a screen shot of a web-based non-human resource management form made available in a preferred embodiment of the line-of-business application of the present invention.

FIG. 6 is a screen shot of a web-based human resource management form made available in a preferred embodiment of the line-of-business application of the present invention.

FIG. 7 is a screen shot of a sub-tab of the web-based human resource management form made available in a preferred embodiment of the line-of-business application of the present invention.

FIG. 8 is a screen shot of a web-based calendar management form made available in a preferred embodiment of the line-of-business application of the present invention.

FIG. 9 is a screen shot of a web-based scheduling calendar used by in-store service provider employees in a preferred embodiment of the line-of-business application of the present invention.

FIG. 10 is a screen shot of a web-based form used to set resource availability by in-store service provider employees in a preferred embodiment of the line-of-business application of the present invention.

FIG. 11 is a screen shot showing a context menu of the web-based in-store scheduling calendar in a preferred embodiment of the line-of-business application of the present invention.

FIG. 12 is a screen shot of a web-based form used to search for a customer record when scheduling a reservation using the in-store scheduling calendar in a preferred embodiment of the line-of-business application of the present invention.

FIG. 13 is a screen shot of a web-based form used to specify reservation details when scheduling a reservation using the web-based in-store scheduling calendar in a preferred embodiment of the line-of-business application of the present invention.

FIG. 14 is a screen shot that shows a scheduled reservation and a reservation context menu on the web-based in-store scheduling calendar in a preferred embodiment of the line-of-business application of the present invention.

FIG. 15 is a screen shot of a web-based scheduling calendar used by service provider customers in a preferred embodiment of the present invention.

FIG. 16 is a screen shot of a customer sign-in and registration screen shown when a customer attempts to schedule a reservation using the web-based scheduling calendar for service provider customers in a preferred embodiment of the present invention.

FIG. 17 is a screen shot of a web-based form used to specify reservation details when scheduling a reservation using the web-based scheduling calendar for service provider customers in a preferred embodiment of the present invention.

FIG. 18 is a screen shot that shows an existing reservation and context menu on the web-based scheduling calendar for service provider customers in a preferred embodiment of the present invention.

FIG. 19 is a representation of the first page of a scheduling wizard made available in the smart phone/mobile phone/personal digital assistant (PDA)-based aggregate resource scheduling software used by service provider customers in a preferred embodiment of the present invention.

FIG. 20 is a representation of the second page of a scheduling wizard made available in the smart phone/mobile phone/PDA-based aggregate resource scheduling software used by service provider customers in a preferred embodiment of the present invention.

FIG. 21 is a representation of the third page of a scheduling wizard made available in the smart phone/mobile phone/PDA-based aggregate resource scheduling software used by service provider customers in a preferred embodiment of the present invention.

FIG. 22 is a representation of the fourth page of a scheduling wizard made available in the smart phone/mobile phone/PDA-based aggregate resource scheduling software used by service provider customers in a preferred embodiment of the present invention.

FIG. 23 is a representation of the fifth page of a scheduling wizard made available in the smart phone/mobile phone/PDA-based aggregate resource scheduling software used by service provider customers in a preferred embodiment of the present invention.

FIG. 24 is a representation of the final page of a scheduling wizard made available in the smart phone/mobile phone/PDA-based aggregate resource scheduling software used by service provider customers in a preferred embodiment of the present invention.

### REFERENCE NUMBERS

1 Data center
2 Web-based line-of-business software
3 Data flow (two-way) of scheduling and other line-of-business information between web-based client software and data center
4 Web-based resource scheduling software
5 Data flow (two-way) of resource scheduling information between web-based scheduling software and data center
6 Smart phone/mobile phone/PDA-based aggregate resource scheduling software
7 Data flow (two-way) of scheduling information between smart phone/mobile phone/PDA-based aggregate resource scheduling software and data center
8 Software clients
9 SOAP messages containing line-of-business information, appointment requests, and error messages
10 HTTP Web Server
11 SOAP message payload
12 XML (Extensible Markup Language) Web Services
13 SQL (Structured Query Language) stored procedures
14 Data store
15 Master database of all service provider databases located elsewhere in the data store and single sign-on customer account information
16 Exemplary service provider chain databases
17 Exemplary line-of-business data stored in a service provider chain database
18 Exemplary resource and calendar (scheduling) data stored in a service provider chain database
19 An Average Service Duration field
20 A scrolling list of defined services
21 A Resource Group
22 A Slot Length field
23 A Default Reservation Duration field
24 A drop-down list of resource groups (in-store calendar)
25 An Add Availability Period context menu option
26 In-store calendar navigation buttons
27 Create Reservation and Remove Availability Period context menu options (in-store calendar)
28 A list of services (in-store calendar)
29 A booked reservation as it appears on the in-store calendar
30 A Reservation context menu
31 A drop-down list of resource groups (customer calendar)
32 “Cannot schedule” notice
33 Customer calendar navigation buttons
34 Create Reservation context menu option (customer calendar)
35 A list of services (customer calendar)
36 Cancel or Modify Reservation context menu options (customer calendar)
37 A Search for Service Providers option
38 A list of service providers (mobile calendar)
39 A list of dates (mobile calendar)
40 A list of resource groups (mobile calendar)
41 A list of resources in a selected resource group (mobile calendar)
42 A list of services offered by a selected resource (mobile calendar)
43 A list of available times for delivery of a selected service (mobile calendar)

### DETAILED DESCRIPTION OF INVENTION

The present invention is a hosted line-of-business application that includes both individual and aggregate service provider resource scheduling. Rather than using ‘decisioning’ mechanisms described in prior art where incoming customer-created reservations receive a status of ‘pending’ until a manual or semi-automatic decision is made to accept or reject the reservation, the present invention assures that a customer-created reservation is valid by pre-qualifying available reservation options and presenting them in real-time to the customer.

Further, the integration of scheduling with the hosted line-of-business application of the present invention provides compelling business value to service providers, encouraging them to participate in the aggregate resource scheduling community, which brings increased value to customers who utilize the aggregate resource scheduling function. As service providers participate in this aggregate resource scheduling community, the unique architecture of the present invention allows each service provider chain to continue operating its business in complete autonomy from other service provider chains also participating in the community, even to the point of allowing each service provider location to make its own resource scheduling calendar available to customers in a standalone fashion.

Because a preferred embodiment of the present invention is hosted at a central data center, it avoids the problems of data concurrency and replication inherent in several scheduling solutions described in prior art by using the same data store for reservations created by service provider employees and service provider customers. Because both employee and customer are reviewing the same data in real-time, problems of double-booking and delayed notification of reservation acceptance or denial are eliminated.

Finally, the architecture of the present invention leverages the same software code (in the preferred embodiment, XML Web Services) to provide scheduling functionality to a variety of software clients, including, but not limited to, web-based calendars and smart phone software applications. In the preferred embodiment, the use of these XML Web Services allows rapid creation of new client scheduling interfaces to harness advancements in consumer technology. The only criterion is that the new technologies be able to communicate with and consume data using formatted messages agreed upon as standard by the technology community.

A. Application Overview

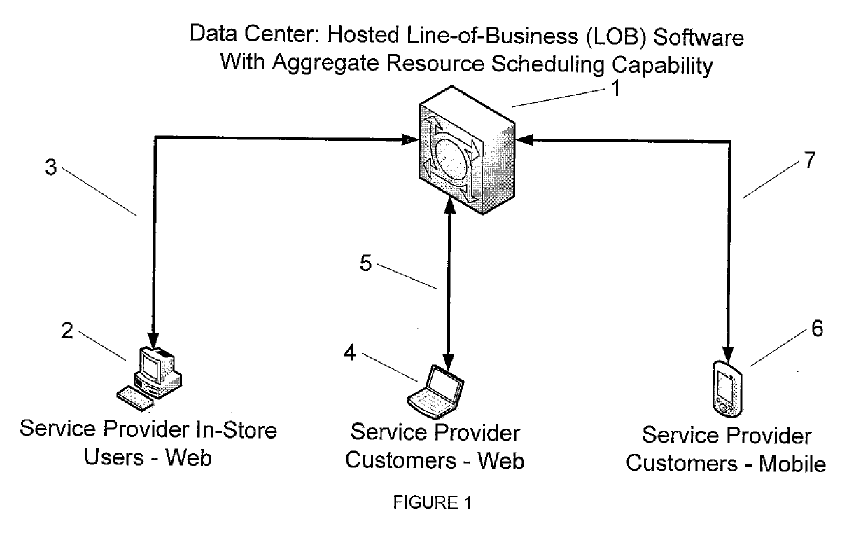

FIG. 1 is a diagram of the network architecture of a preferred embodiment of the present invention. This diagram shows the data center of the present invention 1, the various web 2, 4 and mobile clients 6 that communicate with the software and database located at the data center, and the two-way communication that occurs between the data center and those clients 3, 5, 7. In the preferred embodiment of the present invention, resource scheduling software is included as part of a hosted line-of-business (LOB) software application 1 for service providers operating in various industry verticals, including, but not limited to, hair stylists, massage therapists, physical therapists, estheticians, fitness centers, mechanics, and tanning salons. In a preferred embodiment, the LOB application of the present invention is web-based software 2 that includes point of sale, inventory management, reporting, customer marketing, payroll, and other critical business functionality—in addition to the scheduling functions that allow booking of service provider resources.

Thus, in a single application a service provider can not only manage a daily calendar for resources made available in its enterprise (tennis courts, meeting rooms, massage therapists, personal trainers, etc.), it can also charge customers for services delivered, sell corollary goods and services, order products, manage inventory levels, run reports detailing revenue and cost of goods sold, and monitor employee productivity. Although the bundling of resource scheduling with LOB functionality is not unique, making this functionality available in a hosted environment that concurrently provides standalone and aggregate resource scheduling functionality is unique, as are the variety of scheduling interfaces that are able to take advantage of this resource scheduling model (in the preferred embodiment, in-store web-based calendar for service provider employees 2, location-specific web-based calendar for service provider customers 4, and smart phone/mobile phone/PDA-based aggregate resource scheduling calendar for service provider customers 6).

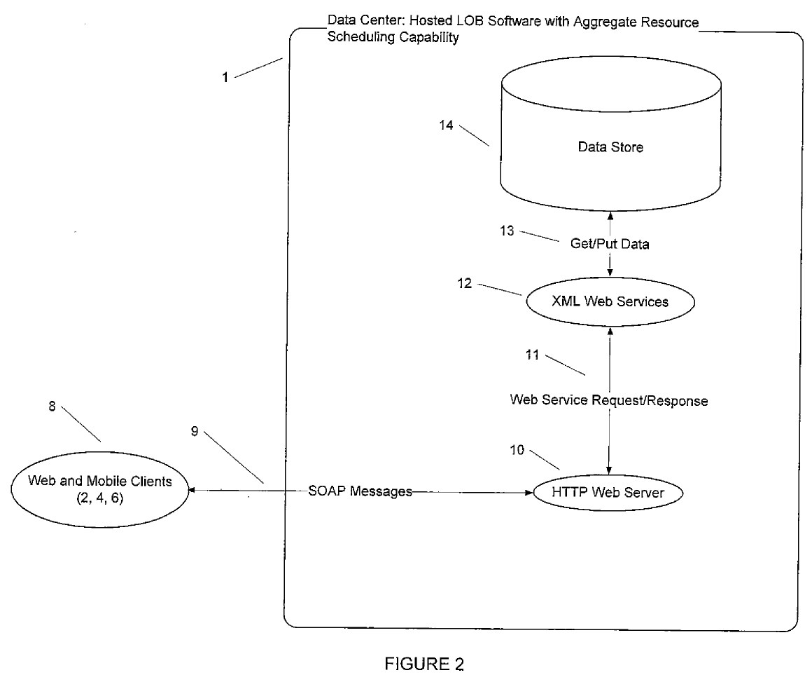

FIG. 2 is a diagram of the software architecture of a preferred embodiment of the present invention. In the preferred embodiment, an HTTP server 10 receives SOAP (Simple Object Access Protocol) messages 9 that contain application instructions (create new appointment, create new human resource, etc.) sent from various software clients 8 to a set of XML Web Services 12. Although the use of SOAP messages is a preferred embodiment, the XML Web Services 12 of the present invention can be invoked using a variety of other, well-known invocation mechanisms, such as RPC (Remote Procedure Call).

The HTTP server 10 brokers the payload 11 of received SOAP messages 9 to the XML Web Services 12. A Web Service is an application that does not have a user interface, but instead is invoked over a local or wide area network by other software to accomplish work. Because Web Services are modular, self-describing, and based on such Internet standards as XML, HTTP, and SMTP, the invoking software need not be written in the same programming language nor run on the same operating system to make use of the Web Service. Thus, while the preferred embodiment invokes XML Web Services written in the C# programming language from web browser-based calendar software written in Ajax and JavaScript 2, 4, the invention's client interface is not limited to this implementation. In another preferred embodiment, the XML Web Services of the present invention can be invoked from an aggregate resource scheduling software application written in C# running on a smart phone or other mobile device 6. It is the client-agnostic nature of this Web Services layer that allows the present invention to easily and rapidly interface with new client software that leverages the latest in consumer technology without requiring a rewrite of underlying business logic or a roll-out of a completely new software system.

In the preferred embodiment, the XML Web Services 12 invoke SQL stored procedures 13 to get data from and put data to the data store 14. If requested, the XML Web Services 12 then format and send 11 data back to the HTTP server 10, which packages the formatted data in a SOAP message 9 and sends it back to the requesting client 8.

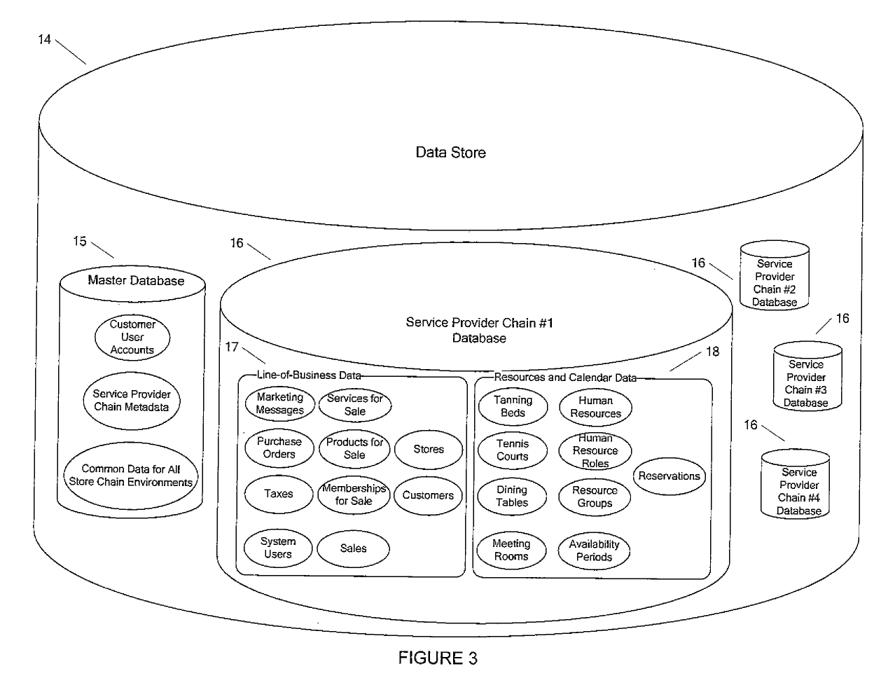

The server-side application elements of the preferred embodiment reside on one or more database, application, and Web PC servers hosted at the central data center 1. FIG. 3 is a diagram of the data store of a preferred embodiment of the present invention. In the preferred embodiment, the data store is composed of a master database 15 and a plurality of service provider chain databases 16. The master database 15 contains metadata (data that describes other data) of all service provider chain databases 16 housed in the data store 14, as well as user accounts for customers who schedule appointments with any of the plurality of service providers using the hosted line-of-business application of the present invention. The master database 15 also contains data common to all service provider chain environments, such as lookup tables containing standard information (i. e., states and provinces, etc.). In the preferred embodiment, a service provider chain database 16 contains all data specific to a particular service provider or chain of related service providers (e.g., a group of service provider locations owned by a single entity or a group of franchised service providers). This data includes, but is not limited to, line-of-business data 17, such as inventory records, service records, membership/package records, sales history, purchase orders, client/customer profiles, email and text messages sent for purposes of marketing or reminding customers of upcoming reservations, and employee user accounts.

Each service provider chain database 16 also contains all data required for the scheduling of human and non-human resources 18, including, but not limited to, human resource records, resource records for various non-human resources that can be booked by customers (tanning beds, tennis courts, dining tables, meeting rooms, etc.), resource groups that organize resources for presentation in various scheduling interfaces, availability periods that define the days and hours a particular resource is available for booking, and reservation records. Each service provider or service provider chain using the line-of-business software of the present invention receives its own service provider chain database 16, ensuring complete separation of all business data from other service providers using the same hosted software application.

In the preferred embodiment, the data store is based on Microsoft SQL Server 2005. In other preferred embodiments, any standard SQL database that supports stored procedures could be substituted for the current database.

B. Setup and Configuration of the Line-of-Business Application

Before a service provider can begin managing resource schedules, the service provider must create database records that correspond to the resources that will be scheduled and the services that those resources provide. In the preferred embodiment of the present invention, this setup of required data takes place in the integrated LOB application. Rather than requiring dual entry of this information (once in a point of sale system to charge for services rendered and a second time in a separate scheduling application such as those described in prior art), the present invention allows the service provider to create and maintain all resource scheduling information in a common database that is monitored using a common set of software tools. This design provides greater flexibility and agility to the service provider, who can rapidly add new services or create special combinations of services and products for customers to purchase based on seasonal or holiday events.

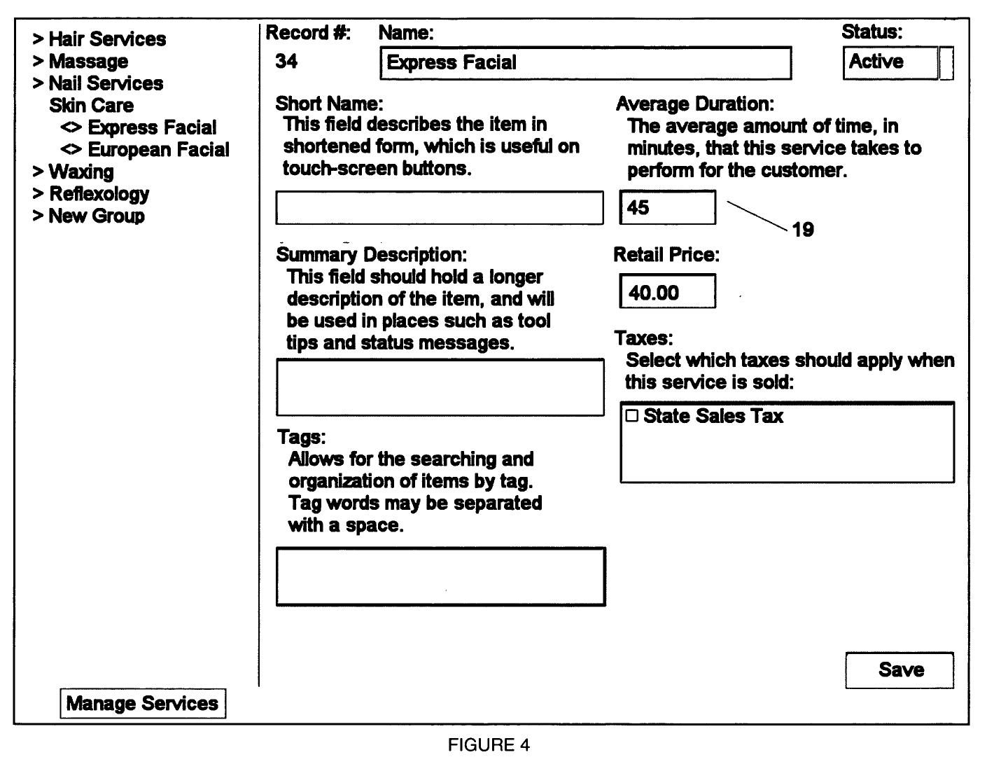

FIG. 4 is a screen shot of a web-based service management form made available in a preferred embodiment of the line-of-business application of the present invention. This form allows service provider employees to define the services offered at a particular service provider location. In the preferred embodiment, the exemplary web-based service management form includes long and short name fields, a means for specifying a status of Active or Inactive for the service record, a field for specifying the average duration of the service 19, a field to record the price that will be charged for delivery of the service, a field to record a description of the service, a field for tags or keywords that can be used to search for the service in other areas of the line-of-business application, and a list of taxes that can be associated with the service and charged when the service is sold using the application's point-of-sale module. The form also includes a Save button to commit any changes made to the service record to the service provider chain database 16. In other preferred embodiments, the service management form may include additional data pertinent to service definition and delivery.

In the preferred embodiment, the duration of the service determines the amount of time a reservation for that service will block out on a scheduling calendar; therefore, if a 30-minute massage requires five minutes of preparation and ten minutes of clean-up, the value specified in the duration field 19 in the service record would be 45 minutes. This ensures that the human resource responsible for delivering the service has adequate time before and after actual service delivery to prepare for the next appointment.

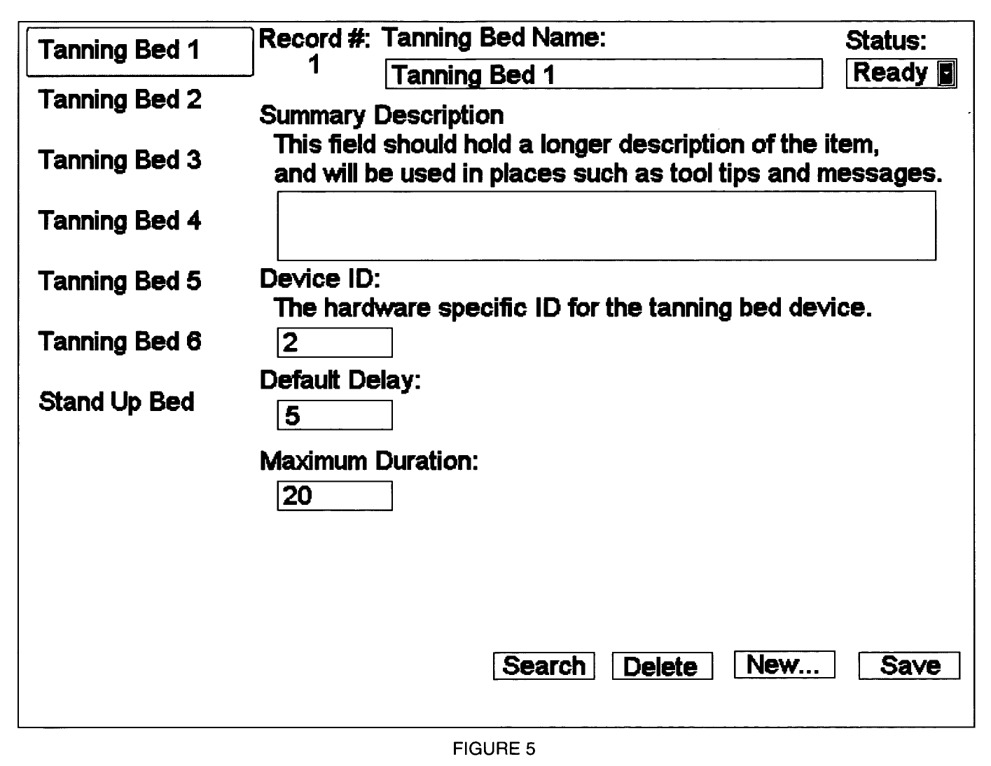

FIG. 5 is a screen shot of a web-based non-human resource management form made available in a preferred embodiment of the present invention's line-of-business application. The non-human resource management forms allow a service provider to define the various non-human resources that will be booked at its facility. In the preferred embodiment, a different management form is available for each type of non-human resource that will be scheduled and managed using the line-of-business application, including, but not limited to, tanning beds, racquet ball courts, tennis courts, swimming pools, meeting rooms, dining tables, and rental golf clubs. In another preferred embodiment, a generic resource management form is available for definition of non-specific resources that will be booked. Fields available on the non-human resource management form will vary depending on the resource managed.

For illustrative purposes, FIG. 5 shows a tanning bed management form that includes a name field, a means for specifying a status of the tanning bed record, a field to record a description of the tanning bed, a field to record the physical device ID of the tanning bed (used to communicate with the specific tanning bed via a separate tanning bed controller), a field to record a default delay period (the time between the send of the START command and the actual start of the tanning bed), and a field to record the maximum time the tanning bed will run once started. All non-human resource management forms in the preferred embodiment include buttons to activate a non-human resource search function, delete the selected non-human resource record, create a new non-human resource record, or commit any changes made to the non-human resource record to the service provider chain database 16.

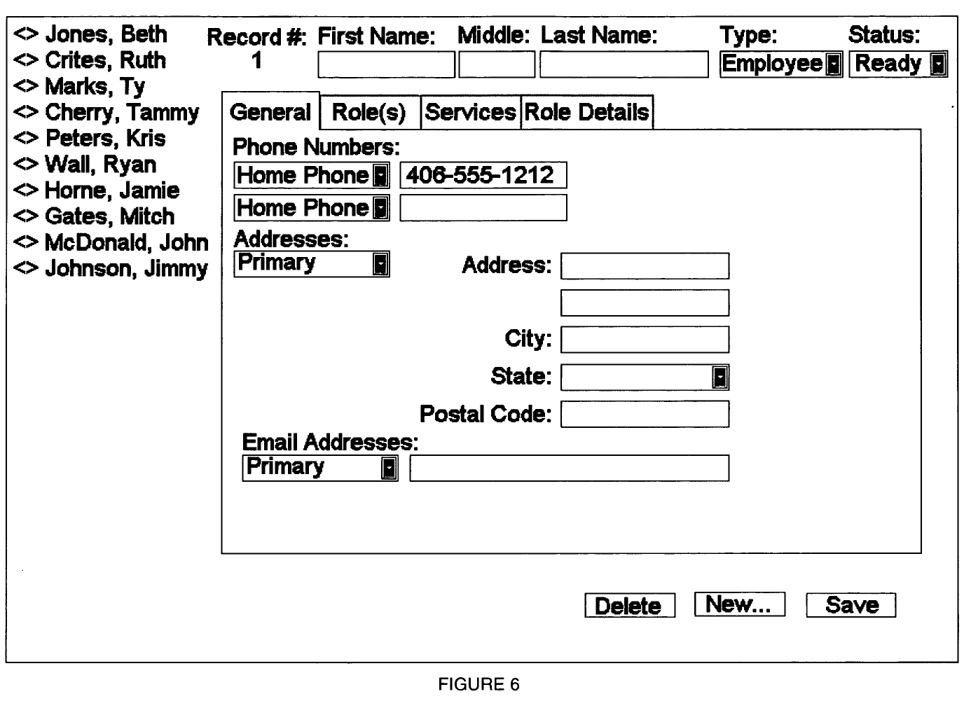

FIG. 6 is a screen shot of a web-based human resource management form made available in a preferred embodiment of the present invention's line-of-business application. In the preferred embodiment, this form includes fields to record the name of the human resource, a means to assign a type (employee or contractor) to the human resource, a means to assign a status to the human resource, and various fields to record common demographic information (phone numbers, addresses, and email addresses). In the preferred embodiment, the human resource management form also allows assignment of one or more roles to the human resource record (massage therapist, esthetician, etc.) and tracking of appropriate information for each assigned role (state license number, etc.). In the preferred embodiment, the human resource management form includes buttons to delete the selected human resource record, create a new human resource record, or commit any changes made to a selected human resource record to the service provider chain database 16.

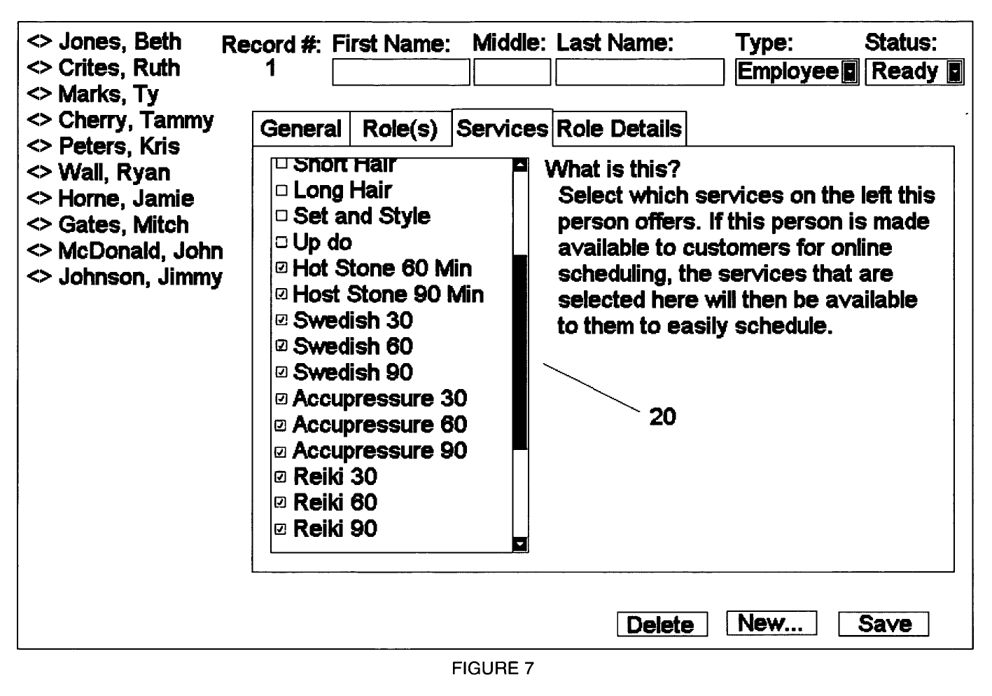

FIG. 7 is a sub-tab of the web-based human resource management form made available in a preferred embodiment of the present invention's line-of-business application. This sub-tab allows the human resource record to be associated with one or more services defined elsewhere in the line-of-business application (see FIG. 4). Services associated with a human resource will be presented to individuals who are booking a reservation with the human resource using one of the various scheduling interfaces made available in the present invention.

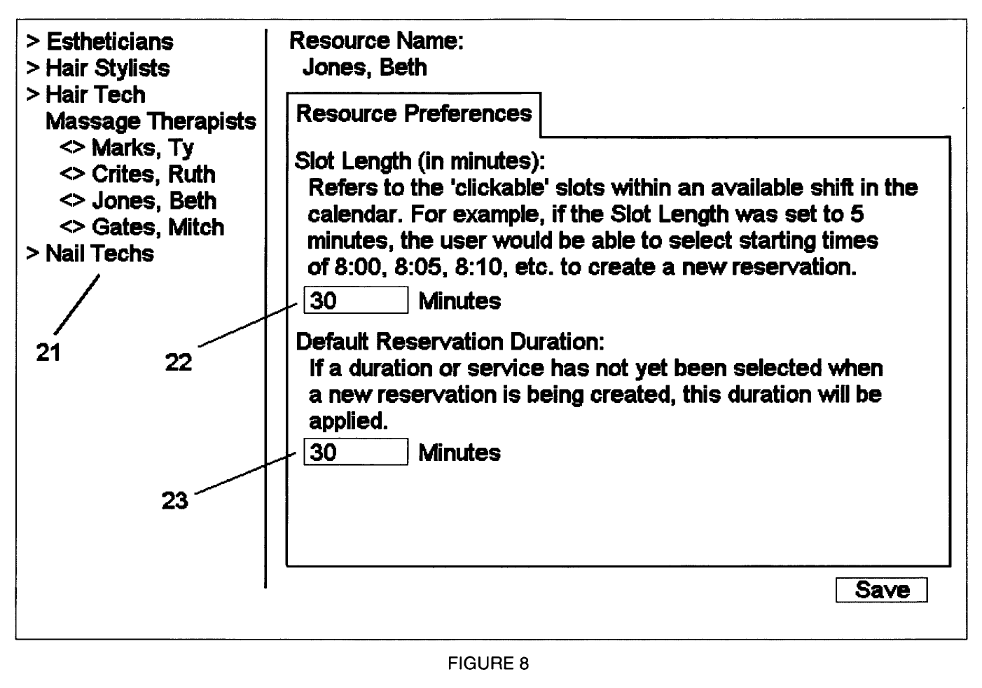

FIG. 8 is a screen shot of a web-based calendar management form made available in a preferred embodiment of the present invention's line-of-business application. In the preferred embodiment, this form includes a list of resources to be presented to individuals who are booking reservations with human and non-human resources using one of the various scheduling interfaces made available in the present invention. This form also allows the service provider employee to create resource groups 21 to organize the list of resources shown in the various scheduling interfaces. For example, the service provider employee might create a resource group called “Massage Therapists” to contain all human resource records that provide massage services. In the preferred embodiment, a single resource can belong to one or more resource groups, allowing the same resource to be viewed in multiple resource groups in the various scheduling interfaces.

In the preferred embodiment, the calendar management form also includes a Slot Length field to allow the service provider to specify—in minutes—the schedulable intervals that will appear on the web-based scheduling calendars available in the preferred embodiment of the present invention. For instance, a specified Slot Length value of ‘10’ indicates that the web-based calendar will allow the resource to be booked at 10 minute intervals.

In the preferred embodiment, the calendar management form also includes a Default Reservation Duration field to allow the service provider to specify—in minutes —the default length of a booked reservation for a non-human resource. The length of a reservation for a human resource is defined by the duration of the service selected when the reservation is created. In the preferred embodiment, service provider employees can override the default reservation duration value at the time of reservation creation; customers cannot override the default reservation duration when self-scheduling using the various customer scheduling interfaces of the present invention. In other preferred embodiments, service providers can use a configuration parameter to specify whether or not employees and/or customers can override default reservation duration values when scheduling reservations for non-human resources.

After configuring services, non-human resources, and human resources and organizing those resources in resource groups, the service provider is ready to begin scheduling resources using the various scheduling interfaces of the present invention.

C. Scheduling Interfaces of the Present Invention

Three distinct client scheduling interfaces are available in the preferred embodiment of the present invention: (1) a web-based in-store calendar that is part of the line-of-business application used by service providers in the day-to-day operations of their enterprise 2; (2) a web-based calendar that is used by customers of a service provider location to view scheduling information and create new reservations for resources available at that location 4; and (3) an aggregate resource scheduling application available for smart phones/mobile phones/PDA devices that allows customers to choose from a plurality of service providers to book a resource reservation 6. All three scheduling interfaces leverage the same XML Web Services to get current calendar information and create new resource reservations.

1. Web-Based In-Store Calendar for Service Provider Employees

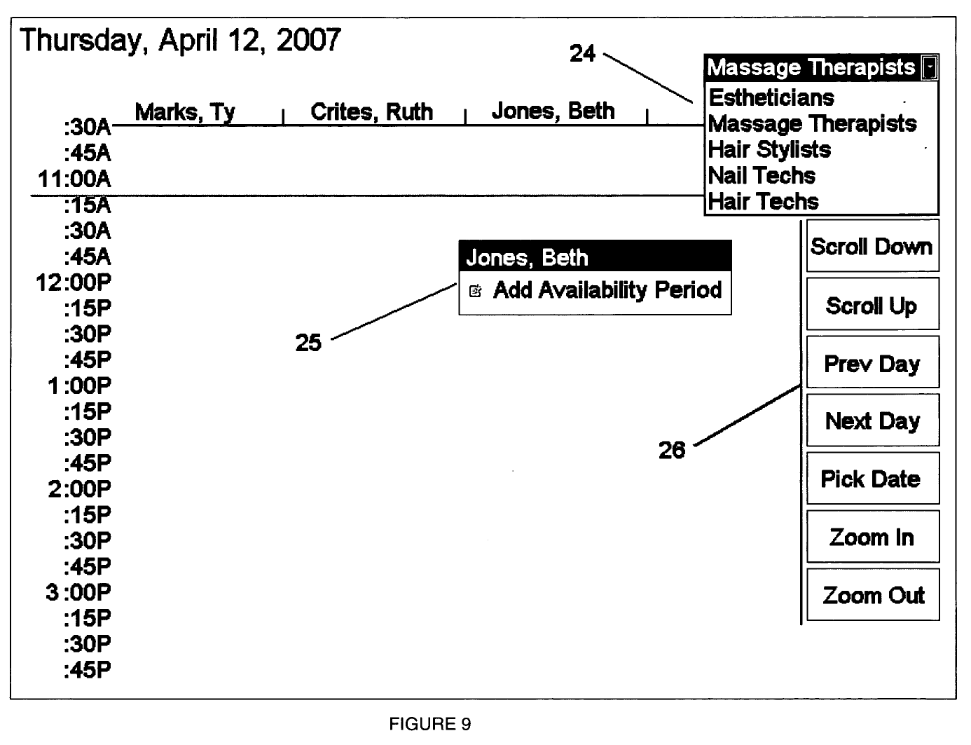

FIG. 9 is a screen shot of a web-based scheduling calendar used by in-store service provider employees in a preferred embodiment of the line-of-business application of the present invention. In a preferred embodiment, this calendar shows a daily schedule for all resources in a resource group selected from a drop-down list of resource groups on the calendar 24. In another preferred embodiment, the in-store calendar displays a weekly schedule for a selected resource. In yet another preferred embodiment, the in-store calendar displays a weekly schedule for all resources in a selected resource group. In still another preferred embodiment, the in-store calendar displays a monthly schedule for a selected resource.

The web-based in-store calendar includes a group of navigation buttons used to manipulate the calendar 26. In the preferred embodiment, these buttons allow the user to shift the calendar left and right, up and down; zoom the display of calendar information in and out; and change the current day for which scheduling information is displayed by moving to the previous day, moving to the next day, or displaying a calendar that allows the user to pick a date to display. In other preferred embodiments, navigation buttons may include options to shift the calendar view by week or by month.

In the preferred embodiment, the web-based in-store calendar is also where service provider employees will define availability periods for each resource to be booked using the calendar. A resource's availability period defines the hours during a given day when that resource can be booked. In the preferred embodiment, the user of the web-based in-store calendar clicks an open area in the column that corresponds to a selected resource to display a context menu that includes an option to add an availability period 25.

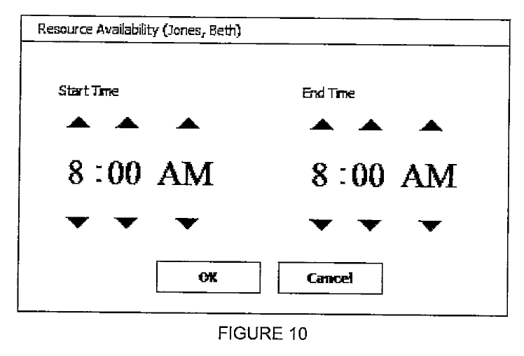

FIG. 10 is a screen shot of a web-based form used to set resource availability by in-store service provider employees in a preferred embodiment of the line-of-business application of the present invention. When a user selects the Add Availability Period option on the in-store calendar's context menu 25, the Resource Availability screen appears. In the preferred embodiment, the Resource Availability screen includes Hour, Minute, and AM/PM controls that the user can manipulate to define the hours when the resource will be available to accept appointments. In the preferred embodiment, a single 24-hour period (one day) can contain one or more availability periods, and availability periods do not need to be contiguous.

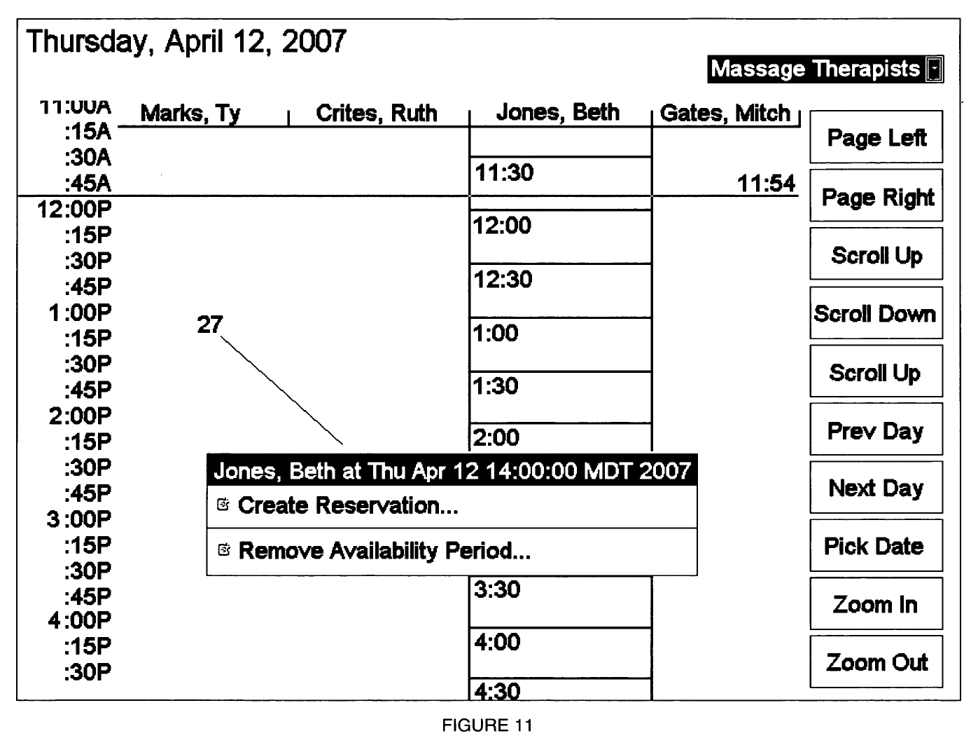

FIG. 11 is a screen shot showing the web-based in-store scheduling calendar with a defined availability period in a preferred embodiment of the line-of-business application of the present invention. After a service provider employee defines an availability period, the resource can be booked using the web-based in-store scheduling calendar, the web-based customer scheduling calendar, or the smart phone/mobile phone/PDA-based aggregate resource scheduling application of the present invention. To schedule a reservation using the web-based in-store calendar in the preferred embodiment, a user clicks a time slot (defined using the Slot Length parameter 22 on the exemplary calendar management form) and chooses Create Reservation from the context menu that displays 27. In the preferred embodiment, this context menu 27 also includes an option to delete the selected availability period. In the preferred embodiment, an availability period can be deleted without affecting the reservations scheduled within it, giving the service provider the option of ending reservations for a particular day after a set number of reservations have been scheduled.

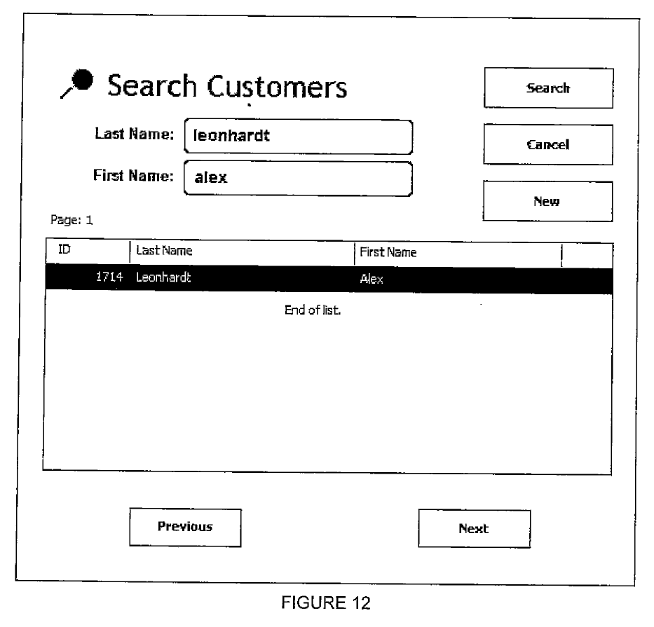

FIG. 12 is a screen shot of a web-based form used to search for a customer record when scheduling a reservation using the in-store scheduling calendar in a preferred embodiment of the line-of-business application of the present invention. This screen appears when the user chooses Create Reservation from an availability period's context menu 27. In the preferred embodiment, the Customer Search screen includes first and last name fields, a Search button to initiate the search using the provided search parameters, a Cancel button to dismiss the screen without retrieving search results, and a button to create a new customer record if no matching record is found as a result of the search. In alternate embodiments, the Customer Search screen includes phone number, postal code, and other fields that can be used as search parameters. Additionally, the screen includes buttons to scroll through a list of search results when provided search parameters return a number of matching results that cannot be displayed on a single screen. In the preferred embodiment, selection of a name from the list of search results associates that customer with the new reservation.

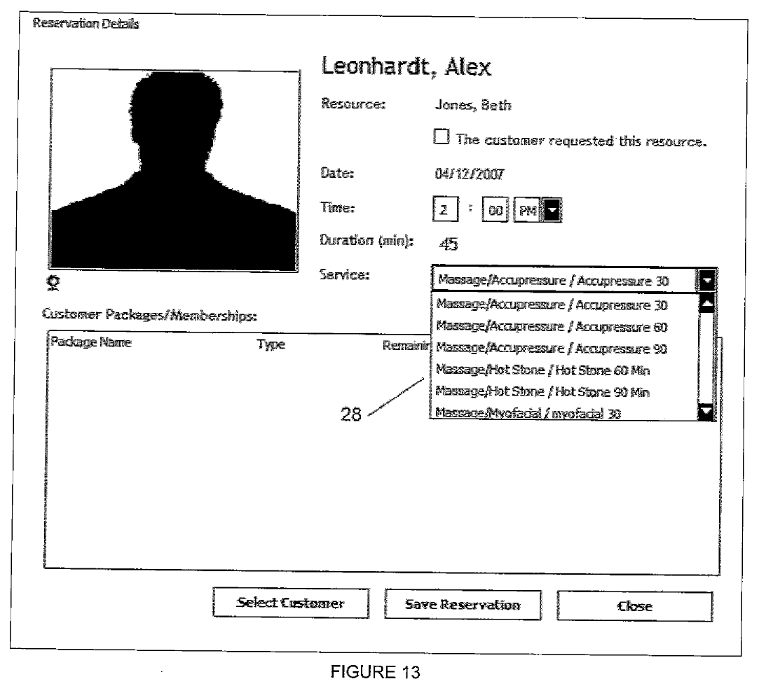

FIG. 13 is a screen shot of a web-based form used to specify reservation details when scheduling a reservation using the web-based in-store scheduling calendar in a preferred embodiment of the line-of-business application of the present invention. In a preferred embodiment, the Reservation Details screen includes the name of the customer selected using the Customer Search screen shown in FIG. 12; the resource selected when the service provider employee chose the Create Reservation option from the resource's availability period context menu 27; a flag indicating that the customer specifically requested the specified resource; the date of the reservation; the time slot selected when the service provider employee chose the Create Reservation option from the resource's availability period context menu 27; a reservation duration that is based on either the selected service (whose duration was defined using the service management screen's Default Duration parameter 19) for human resources or, for non-human resources, the value specified in the Default Duration field 23 on the calendar management screen; a drop-down list of services 28 offered by the selected human resource (defined using the Services list 20 in the human resource management form); and a list of packages (memberships) currently on file for the selected customer. In the preferred embodiment, the Reservation Details screen does not include the drop-down list of Services 28 when booking a non-human resource. The form also includes buttons to change the current customer associated with the reservation, save the reservation data to the service provider chain database 16, or close the screen without saving reservation information.

In the preferred embodiment, the services listed in the drop-down list of Services 28 are filtered by an XML Web Service 12 based on the start time of the current reservation and the start time of the next reservation for the selected resource. The list includes only those services that can be completed (based on duration) in the time period before the start of the next appointment. In another preferred embodiment, the service provider can configure the drop-down list of services 28 to be unfiltered, resulting in possible double-bookings when the duration of a selected service causes the reservation to extend into the next scheduled appointment.

In the preferred embodiment, the service provider employee can manipulate the start time to deviate from the time slot selected on the web-based in-store calendar. In another preferred embodiment, the service provider can configure the time fields to be disabled, disallowing any deviation in start times from those imposed by the values defined in the resource's Slot Length field 22 on the calendar management screen.

After the service provider employee chooses a service from the drop-down list of services 28 and clicks Save Reservation, the XML Web Services 12 update the service provider chain database 16 with the reservation information. In the preferred embodiment, no restriction is placed on double-booking when booking a reservation using the web-based in-store calendar, so the XML Web Services 12 do not check for existing reservations in the selected time slot before committing the reservation data to the service provider chain database 16. In another preferred embodiment, the system can be configured by the service provider to disallow double-booking when scheduling using the web-based in-store calendar; in this scenario, the XML Web Services 12 do a final check before committing the reservation to ensure that another reservation has not already been scheduled in the selected time slot between the time the user selected the Create Reservation option from the availability period context menu 27 and clicked the Save Reservation button on the web-based Reservation Details screen. In this preferred embodiment, if the XML Web Services 12 are configured to disallow double-booking and detect an existing reservation when attempting to save a new reservation, an error message is returned to the web-based in-store calendar notifying the user that the reservation cannot be scheduled in the time slot selected. In another preferred embodiment, the double-booking error can raise a warning that allows the user to proceed with the double-book after reviewing the situation.

In the preferred embodiment of the present invention, other instances of the web-based in-store calendar poll at configurable intervals for updates to reservation information and will be updated with new reservation information during the next polling cycle (which typically occurs every few seconds). In the preferred embodiment, available time slots appear in a distinct color from booked reservations; this allows the service provider employee to determine at a glance which time slots are available for reservations when reviewing a resource's schedule. Because each instance of the web-based in-store scheduling calendar is updated continually with reservations created or cancelled elsewhere, the user of the calendar is dealing with scheduling information that is current up to the second.

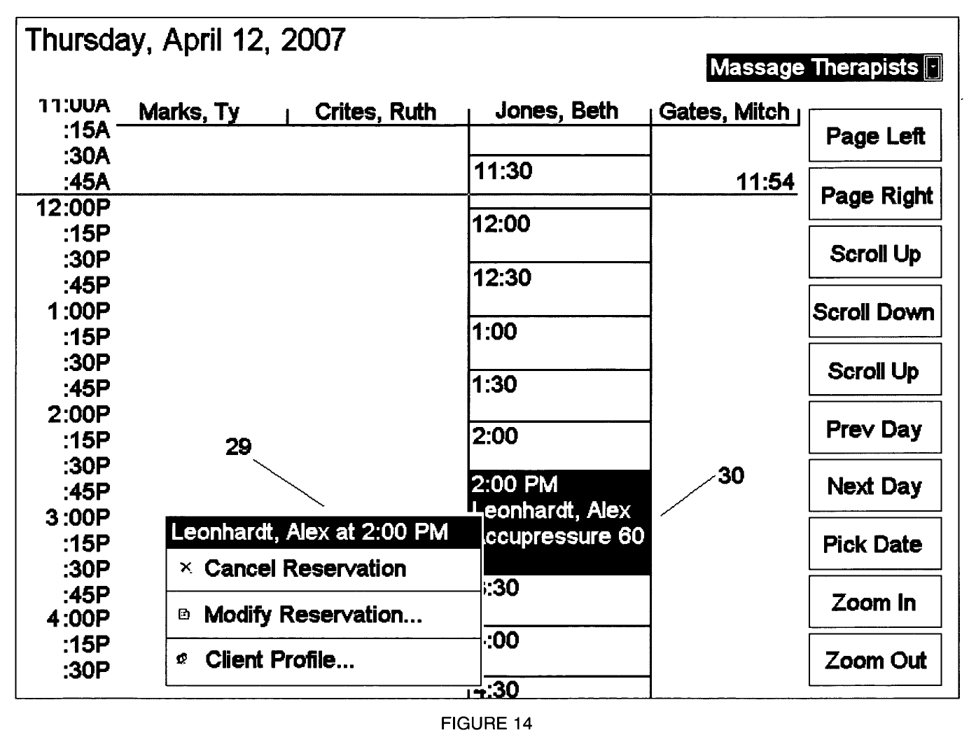

FIG. 14 is a screen shot that shows a scheduled reservation and a reservation context menu on the web-based in-store scheduling calendar in a preferred embodiment of the line-of-business application of the present invention. In the preferred embodiment, the service provider employee can use the options on the reservation context menu to cancel the reservation, launch the web-based Reservation Details form to modify the reservation data, or launch a web-based LOB module to view or update the profile information for the customer associated with the reservation. In another preferred embodiment, the reservation context menu can include one or more options valid for the type of non-human resource that has been reserved. For example, the context menu may include an option to issue a START command if the reserved resource is a tanning bed.

2. Web-Based Calendar for Customers of a Service Provider

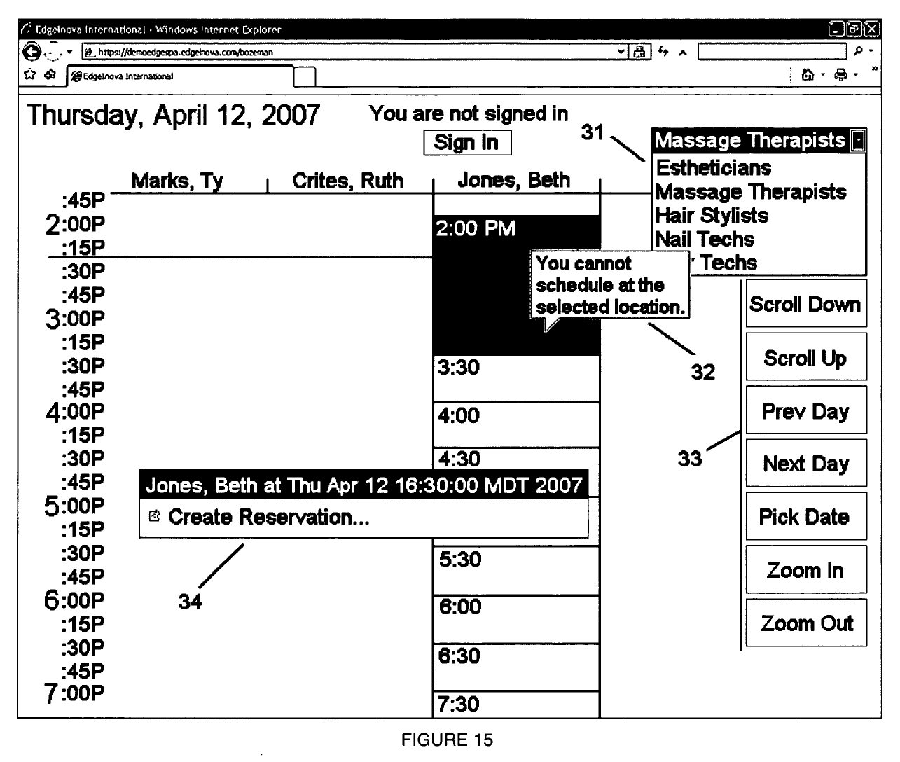

FIG. 15 is a screen shot of a web-based scheduling calendar used by service provider customers in a preferred embodiment of the present invention. Customers navigate to this web-based customer calendar by pointing a web browser at a URL that corresponds to a specific service provider location. A service provider can provide a hyperlink to the web-based customer calendar from its corporate web site or distribute the customer calendar URL on receipts, in email marketing messages sent from the LOB application of the present invention, or by advertising the URL using traditional means. In a preferred embodiment the web-based customer calendar shows resources for a single service provider location, even if the service provider is part of a service provider chain that includes multiple locations. In another preferred embodiment, the web-based customer calendar includes a store chooser that allows the customer to browse the resource calendars of other service provider locations in the same service provider chain. In still another preferred embodiment, the customer can navigate to a location selection web page that provides hyperlinks to each service provider location defined in the service provider chain database.

The focus of the web-based customer calendar on a single service provider provides complete separation of one service provider calendar from another, allowing each service provider to tout the advantages and convenience of online self-scheduling to its customers without risking the loss of those customers to competing service providers who may also be participating in the aggregate resource scheduling community.

In the preferred embodiment, the web-based customer calendar is very similar to the web-based in-store calendar for service provider employees but has restricted functionality to make it appropriate for customer self-scheduling. In a preferred embodiment, this calendar shows a daily schedule for all resources in a resource group selected from a drop-down list of resource groups on the calendar 31. In another preferred embodiment, the web-based customer calendar displays a weekly schedule for a selected resource. In yet another preferred embodiment, the web-based customer calendar displays a weekly schedule for all resources in a selected resource group. In still another preferred embodiment, the web-based customer calendar displays a monthly schedule for a selected resource.

The web-based customer calendar includes a group of navigation buttons used to manipulate the calendar 33. In the preferred embodiment, these buttons allow the customer to shift the calendar left and right, up and down; zoom the display of calendar information in and out; and change the current day for which scheduling information is displayed by moving to the previous day, moving to the next day, or displaying a calendar that allows the customer to pick a date to display. In other preferred embodiments, navigation buttons may include options to shift the calendar view by week or by month.

In the preferred embodiment, a customer is not required to sign in to use the web-based customer calendar to check resource availability or begin the process of creating a reservation. In another preferred embodiment, the web-based customer calendar can be configured to require customer sign-in before the calendar displays any resource scheduling information for the service provider location; the customer calendar includes a button to allow the customer to sign in without creating a reservation.

In the preferred embodiment, the web-based customer calendar displays existing reservations in a different color to signify that one or more time slots are not available for scheduling. In those configurations where customer sign-in is required, details of existing reservations are never displayed to customers who are not signed in; after customer sign-in, details of existing reservations scheduled by or for the signed-in customer are displayed on the calendar.

To schedule a reservation using the web-based customer calendar, a customer selects (‘clicks’) an empty time slot (defined using the Slot Length parameter 22 on the exemplary calendar management form) in a defined availability period and chooses Create Reservation from the context menu that displays 34. In the preferred embodiment, a click in a resource column that does not contain an availability period provides no customer feedback: no warning is displayed and no context menu is shown. In the preferred embodiment, double-booking is not allowed in the web-based customer calendar: a click on an existing reservation shows a warning notifying the customer that a reservation cannot be scheduled in the selected time slot 32. In the preferred embodiment, the web-based customer calendar includes a thin line that shows the current time at the service provider's location. The web-based customer calendar does not allow customers to create reservations in time slots that are in the past and a click in a time-slot prior to the current time displays a warning notifying the customer that a reservation cannot be scheduled in the selected time slot 32.

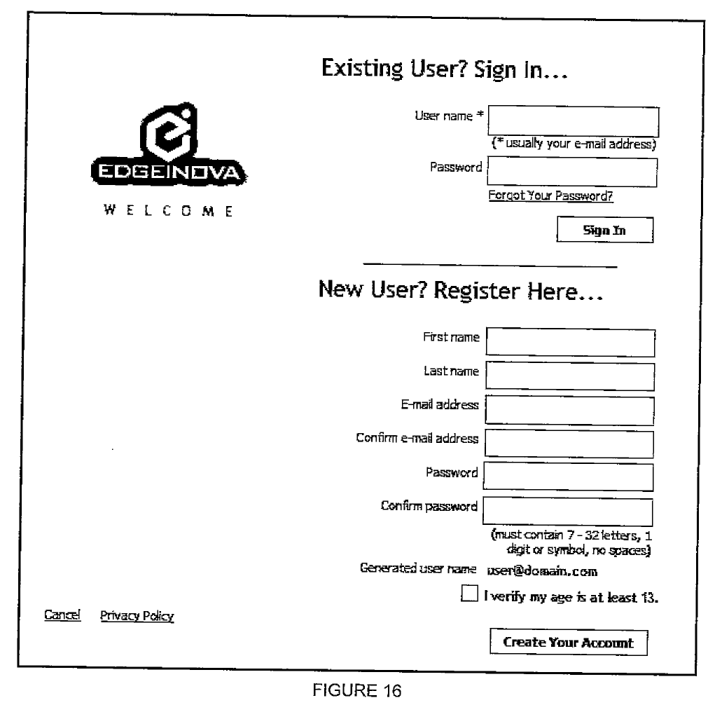

FIG. 16 is a screen shot of a customer sign-in and registration screen shown when a customer attempts to schedule a reservation using the web-based scheduling calendar for service provider customers in a preferred embodiment of the present invention. The sign-in screen includes User Name and Password fields for customers who have previously used the web-based customer calendar of the present invention to self-schedule a reservation at any service provider location in the hosted resource scheduling network. In the preferred embodiment, customer user accounts are stored in the master database 15 separate from customer profile information that is stored in the plurality of service provider chain databases 16.

This architecture allows a single customer user account to be associated with customer profile data that exists in multiple, autonomous service provider chain databases 16, providing the customer with a single credential that can be used to schedule reservations at any service provider location in the resource scheduling network. Yet even while this architecture provides the customer with single sign-in capability, it also preserves the proprietary customer profile data stored in each service provider chain database 16 because no data is ever shared between service providers. This feature is essential for service providers who often base the value of their business on the size and quality of their customer book.

For new customers, the sign-in screen includes fields a customer can populate to create a new customer account in the present invention's master database 15: first and last name fields, email and email confirmation fields, password and password confirmation fields, and an age verification check box. When a customer clicks a Create Your Account button to initiate the process of creating a new user account, the XML Web Services 12 check for duplicate user accounts in the master database 15 before inserting the new user record. If a duplicate record is found, the system displays a message notifying the customer that she should attempt to log in using her existing user account and password.

In the preferred embodiment, when a customer signs in using an existing user account or creates a new user account, the XML Web Services 12 insert a new record in the Customer table of the service provider chain database 16 if this is the first time the customer has signed in to a location in that service provider's network of locations (i.e., service provider chain). If the customer logs in with an existing user account and has previously signed in to the web-based customer calendar of one of the locations in the service provider chain, the XML Web Services 12 do not create a new customer record because the customer's user account is already associated with an existing customer record in the service provider chain database 16.

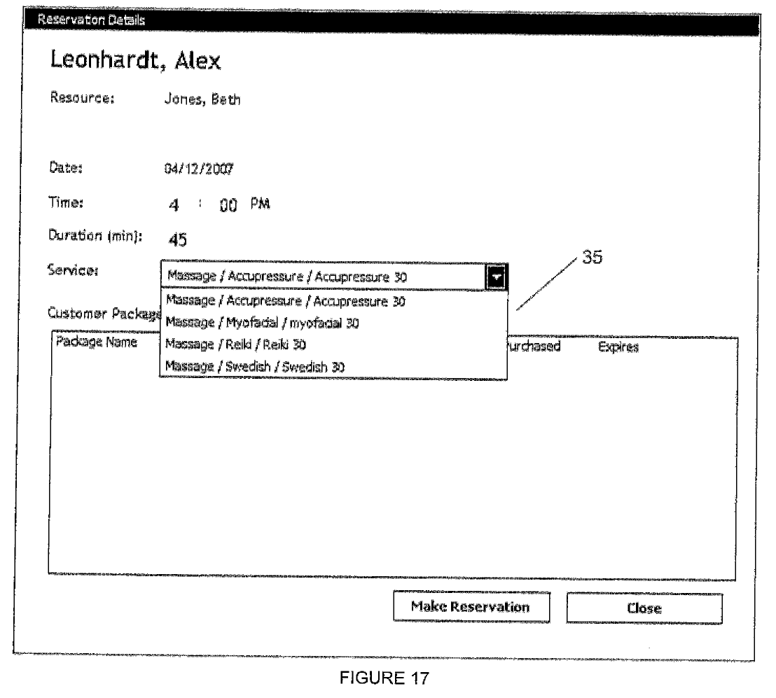

FIG. 17 is a screen shot of a web-based form used to specify reservation details when scheduling a reservation using the web-based scheduling calendar for service provider customers in a preferred embodiment of the present invention. In a preferred embodiment, the Reservation Details screen includes: the name of the customer associated with the user account used to sign in using the sign-in page shown in FIG. 16; the resource selected when the customer chose the Create Reservation option from the resource's availability period context menu 34; the date of the reservation; the time slot selected when the customer chose the Create Reservation option from the resource's availability period context menu 34; a reservation duration that is based on either the selected service (whose duration was defined using the service management screen's Default Duration parameter 19) for human resources or, for non-human resources, the value specified in the Default Duration field 23 on the calendar management screen; a drop-down list of services 35 offered by the selected human resource (defined using the Services list 20 in the human resource management form); and a list of packages (memberships) currently on file for the customer profile associated with the user account used to sign in. In the preferred embodiment, the Reservation Details screen does not include the drop-down list of Services 35 when a customer is booking a non-human resource. The form also includes buttons to save the reservation data to the service provider chain database 16 or close the screen without saving reservation information.

In the preferred embodiment, the services listed in the drop-down list of Services 35 are filtered by an XML Web Service 12 based on the start time of the current reservation and the start time of the next reservation for the selected resource. The list includes only those services that can be completed (based on duration) in the time period before the start of the next appointment. In another preferred embodiment, the service provider can configure the drop-down list of services 35 to be unfiltered, resulting in possible double-bookings when the duration of a selected service causes the reservation to extend into the next scheduled appointment.

In the preferred embodiment, customers cannot manipulate the start time of the reservation to deviate from the time slot selected on the web-based customer calendar. In another preferred embodiment, the service provider can configure the time fields to be enabled, allowing the customer to deviate the reservation start time from those imposed by the values defined in the resource's Slot Length field 22 on the calendar management screen.

After the customer chooses a service from the drop-down list of services 35 and clicks Make Reservation, the XML Web Services 12 update the service provider chain database 16 with the reservation information. In the preferred embodiment, a restriction is placed on double-booking when booking a reservation using the web-based customer calendar, so the XML Web Services 12 check for existing reservations in the selected time slot before committing the reservation data to the service provider chain database 16. In this scenario, the XML Web Services 12 do a final check before committing the reservation to ensure that another reservation has not already been scheduled in the selected time slot between the time the customer selected the Create Reservation option from the availability period context menu 34 and clicked the Save Reservation button on the web-based Reservation Details screen. In this preferred embodiment, if the XML Web Services 12 are configured to disallow double-booking and detect an existing reservation when attempting to save a new reservation, an error message is returned to the web-based customer calendar notifying the customer that the reservation cannot be scheduled in the time slot selected. The customer can then select another open time slot to repeat the appointment request process. In an embodiment that is not preferred, the system can be configured by the service provider to allow double-booking when scheduling using the web-based customer calendar. In this case, the XML Web Services 12 do not check for existing reservations in the selected time slot before committing the reservation data to the service provider chain database 16.

In the preferred embodiment of the present invention, instances of the web-based in-store calendar and other instances of the web-based customer calendar poll at configurable intervals for updates to reservation information and will be updated with new reservation information during the next polling cycle (which typically occurs every few seconds). Because the web-based customer calendar is updated every few seconds to reflect changes made to schedule information by service provider employees and other customers, each customer can determine in real-time the dates and times when a desired resource is available for booking before attempting to create a reservation, thereby eliminating the double-booking errors and delayed scheduling “requests” common in the scheduling systems of prior art.

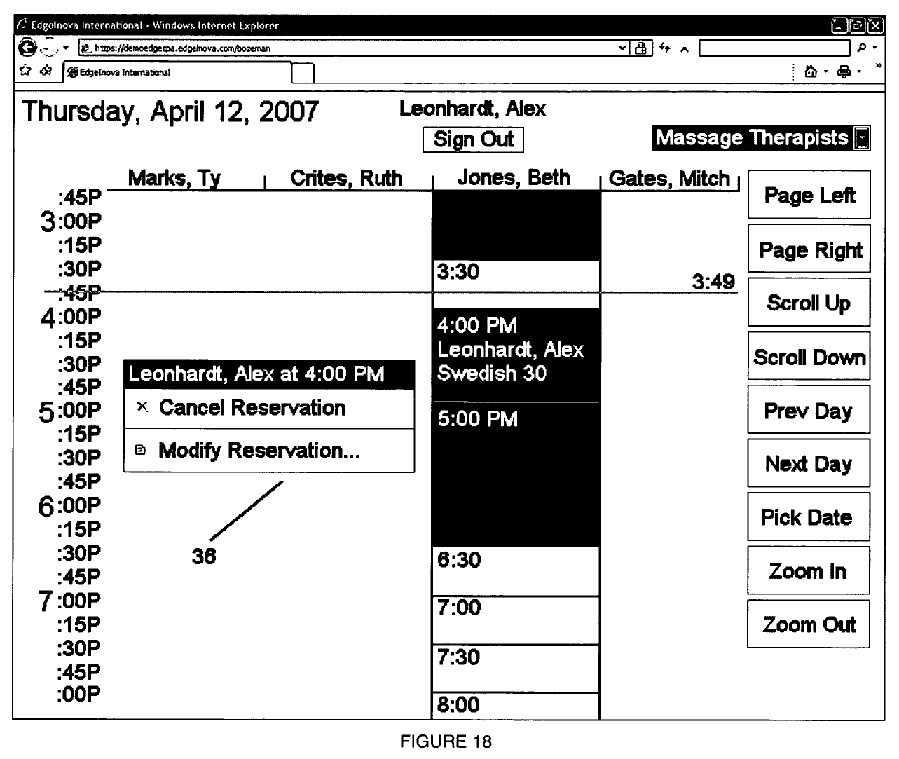

FIG. 18 is a screen shot that shows a scheduled reservation and a reservation context menu on the web-based scheduling calendar for service provider customers in a preferred embodiment of the present invention. In the preferred embodiment, the customer can use the options on the reservation context menu to cancel the reservation or launch the web-based Reservation Details form to modify existing reservation data.

In the preferred embodiment of the present invention, no distinction is made between reservations created by service provider employees on behalf of a customer or reservations self-scheduled by a customer. In another preferred embodiment, the web-based customer calendar can be configured to allow the customer to cancel and modify only those reservations he or she has self-scheduled. In still another preferred embodiment, the web-based customer calendar can be configured to disallow cancellation or modification of any reservation; this configuration forces the customer to contact the service provider directly to cancel or modify a scheduled appointment. In yet another preferred embodiment, the web-based customer calendar can be configured to charge the customer a cancellation fee when the customer cancels a scheduled appointment based on the reserved service or resource, the number of previous no-shows or cancellations the customer has on file, or other criteria specified by the service provider. In this preferred embodiment, customers can pay cancellation fees on the spot using a credit card or choose to add the bill to an in-house credit account that is managed by the service provider using the present invention's LOB application.

3. Smart Phone/Mobile Phone/PDA-Based Aggregate Resource Scheduling Application

In addition to the web-based in-store and web-based customer calendars discussed above, the present invention allows reservations to be made using a mobile scheduling interface. That interface could be a smart phone, a mobile phone, a PDA or any other mobile device from which the aggregate resource scheduling software of the present invention can be downloaded.

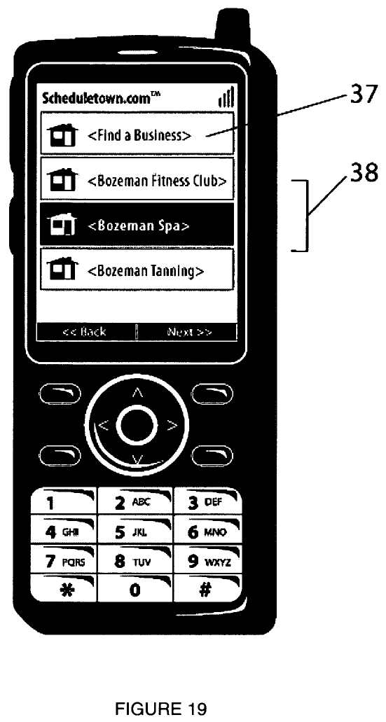

FIG. 19 is a representation of the first page of a scheduling wizard made available in the smart phone/mobile phone/PDA-based aggregate resource scheduling software used by service provider customers in a preferred embodiment of the present invention. In another preferred embodiment, the aggregate resource scheduling application may be made available via a variety of electronic means, including, but not limited to, PC software, interactive web pages, applets delivered via the web or another network, and interactive consumer modules delivered via cable or satellite TV.

In the preferred embodiment, customers download and install this application on their mobile device; the application contacts the same XML Web Services 12 used by the various web-based scheduling interfaces discussed elsewhere in this application to get scheduling information and create new reservations.

In the preferred embodiment, customers use options on the first page of the scheduling wizard to select the service provider with which they wish to create a reservation. In a preferred embodiment, the page includes a search option 37 that allows a customer to search for service providers using a variety of search methods, including, but not limited to, zip code search, global positioning system (GPS) coordinate search, city search, county search, area code search, and service provider category search, Aggregate information about all service provider chains in the network is available in the data store's master database 15.

In the preferred embodiment, the first page of the scheduling wizard also includes a list of service providers with which the customer has previously scheduled appointments using the mobile scheduling wizard 38. In a preferred embodiment, this information is cached locally on the mobile device where it can be quickly accessed by the mobile scheduling application. In another preferred embodiment, this data is stored as part of the customer's user account in the master database 15, making this data available for reference on any of the variety of customer scheduling interfaces.

Whether located using a search or by scrolling through a list of previously reserved service provider locations, in the preferred embodiment selection of a service provider location sends the selected information to an XML Web Service 12 and requests date information that will display on the next page of the mobile scheduling wizard.

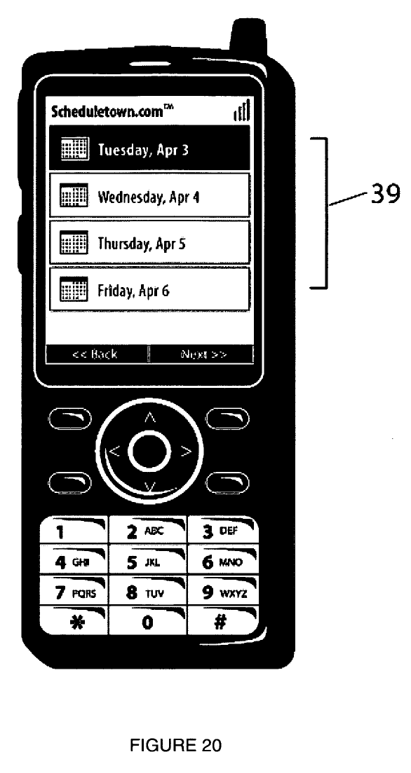

FIG. 20 is a representation of the second page of a scheduling wizard made available in the smart phone/mobile phone/PDA-based aggregate resource scheduling software used by service provider customers in a preferred embodiment of the present invention. The second page of the mobile scheduling wizard displays a list of dates on which the selected service provider is willing to accept appointments self-scheduled by customers 39. In the preferred embodiment, these dates are configured by the service provider using the LOB application of the present invention. In the preferred embodiment, selection of a date sends the selected information to an XML Web Service and requests resource group information that will display on the next page of the mobile scheduling wizard.

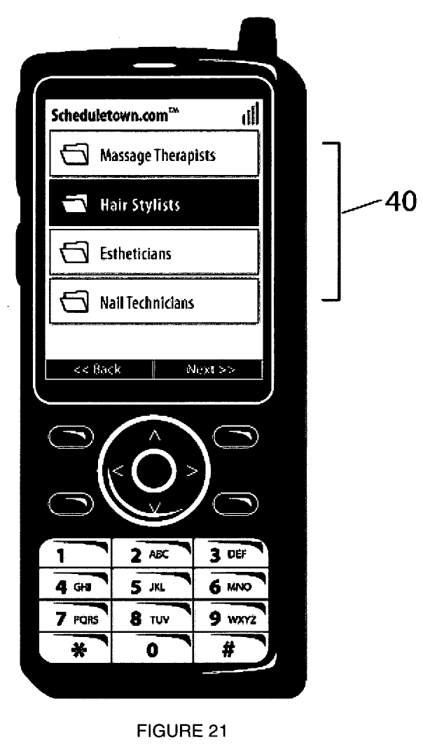

FIG. 21 is a representation of the third page of a scheduling wizard made available in the smart phone/mobile phone/PDA-based aggregate resource scheduling software used by service provider customers in a preferred embodiment of the present invention. The third page of the mobile scheduling wizard displays a list of resource groups 40 defined by the selected service provider to organize the resources offered at the service provider's location. The resource groups shown on this list are the same as those shown in the resource group drop-down lists on the web-based in-store and customer calendars 24, 31. In the preferred embodiment, selection of a resource group sends the selected information to an XML Web Service 12 and requests resource information that will display on the next page of the mobile scheduling wizard.

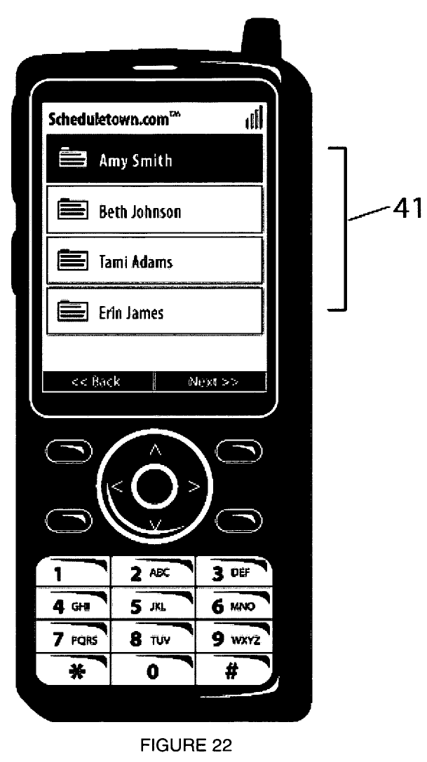

FIG. 22 is a representation of the fourth page of a scheduling wizard made available in the smart phone/mobile phonePDA-based aggregate resource scheduling software used by service provider customers in a preferred embodiment of the present invention. The fourth page of the mobile scheduling wizard displays a list of resources 41 found in the resource group selected on the previous wizard page. The resources shown on this list are the same as those shown as column headers at the top of the web-based in-store and customer calendars. In the preferred embodiment, selection of a resource sends the selected information to an XML Web Service 12 and requests either service information (for human resources) or available time slot information that will display on the next page of the mobile scheduling wizard.

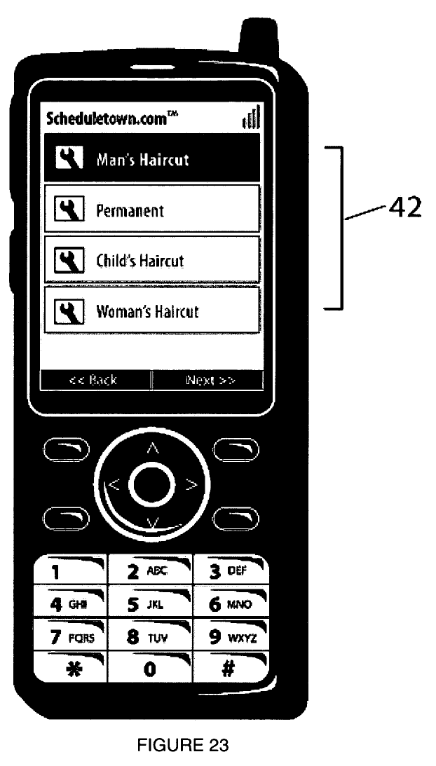

FIG. 23 is a representation of the fifth page of a scheduling wizard made available in the smart phone/mobile phone/PDA-based aggregate resource scheduling software used by service provider customers in a prefered embodiment of the present invention. The fifth page of the mobile scheduling wizard displays a list of services 42 associated with a human resource selected on the previous page of the scheduling wizard. Display of this page of the wizard is conditional and dependent on the type of resource selected on the previous page. If the customer selects a non-human resource, the Service selection page is not displayed. The services shown on this list are the same as those shown in the service drop-down lists found on the Reservation Details screens available in the web-based in-store and customer calendars 28, 35, with the exception that the services list in the mobile scheduling wizard is not filtered because no start time has yet been specified. In the preferred embodiment, selection of a service sends the selected information to an XML Web Service 12 and requests available time slot information that will display on the next page of the mobile scheduling wizard.

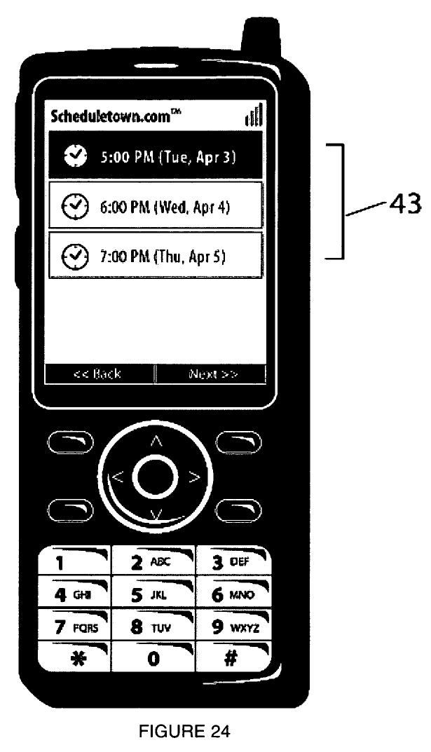

FIG. 24 is a representation of the final page of a scheduling wizard made available in the smart phone/mobile phone/PDA-based aggregate resource scheduling software used by service provider customers in a preferred embodiment of the present invention. The final page of the mobile scheduling wizard displays a list of dates and times 43 that match the criteria specified by the customer on previous pages of the wizard and that are currently available for reservation.

When the customer chooses a date/time from the final page of the mobile scheduling wizard, the XML Web Services 12 update the service provider chain database 16 with the reservation information. In the preferred embodiment, a restriction is placed on double-booking when booking a reservation using the mobile scheduling application, so the XML Web Services 12 check for existing reservations in the selected time slot before committing the reservation data to the service provider chain database 16. In this scenario, the XML Web Services 12 do a final check before committing the reservation to ensure that another reservation has not already been scheduled in the selected time slot between the time the customer started the mobile scheduling wizard by choosing a service provider and clicked an available date/time on the wizard's final page. In this preferred embodiment, if the XML Web Services 12 are configured to disallow double-booking and detect an existing reservation when attempting to save a new reservation, an error message is returned to the mobile application user notifying him or her that the reservation cannot be scheduled in the time slot selected. The customer can then select another open time slot to repeat the appointment request process. In an embodiment that is not preferred, the system can be configured by the service provider to allow double-booking when scheduling using the mobile scheduling application. In this case, the XML Web Services 12 do not check for existing reservations in the selected time slot before committing the reservation data to the service provider chain database 16.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A system for real-time resource scheduling comprising:
(a) a hosted line-of-business software application for service providers operating in various industry verticals;
(b) a central data center;
(c) an in-store web-based calendar for service provider employees;
(d) a web-based calendar for service provider customers; and
(e) a mobile customer scheduling interface;
wherein the central data center comprises a data store;
wherein the data store comprises a master database and a plurality of service provider chain databases;
wherein the master database contains metadata of all service provider chain databases housed in the data store;
wherein the master database contains user accounts for customers who make reservations with any of the service providers;
wherein each service provider has a service provider chain database that is specific to that service provider;
wherein customer profile information is stored in the service provider chain databases;
wherein a customer's user account is associated with customer profile data for that customer in multiple, autonomous service provider chain databases;
wherein no data is shared between service providers;
wherein each service provider creates and maintains all resource scheduling information for its own human and non-human resources;
wherein the resource scheduling information comprises availability information;
wherein a customer uses either the web-based customer calendar or the mobile scheduling interface to make a reservation for a resource;
wherein when the customer accesses the web-based calendar or the mobile scheduling interface to make a reservation, only the time slots for which the resource is available are made available to the customer for a new reservation;
wherein a service provider employee uses the web-based in-store calendar to make a reservation for a resource on behalf of a customer;
wherein when a reservation is made by a customer or a service provider employee, the reservation information is transmitted in real-time to the service provider chain database; and
wherein instances of the web-based in-store calendar and the web-based customer calendar poll at configurable intervals for updates to reservation information and are updated with new reservation information during each subsequent polling cycle.

2. The system of claim 1, wherein the configurable interval is several seconds.

3. The system of claim 1, wherein the web-based customer calendar shows resources only for a single service provider.

4. The system of claim 1, wherein the web-based customer calendar displays existing reservations in a different color to signify that one or more time slots are not available for scheduling.

5. The system of claim 1, wherein the web-based in-store calendar displays existing reservations in a different color to signify that one or more time slots are not available for scheduling.

6. The system of claim 1, wherein the service provider chain database comprises a customer table, and wherein when a customer signs in using an existing user account or creates a new user account, the system inserts a new record in the customer table of the service provider chain database if this is the first time the customer has signed in to a location in that service provider's network of locations.

7. The system of claim 1, wherein each service provider chain database contains data specific to a particular service provider or chain of related service providers.

8. The system of claim 7, wherein the data specific to a particular service provider or chain of related service providers comprises inventory records, service records, membership/package records, sales history, purchase orders, client/customer profiles, email and text messages sent for purposes of marketing or reminding customers of upcoming reservations, and/or employee user accounts.

9. The system of claim 7, wherein the data specific to a particular service provider or chain of related service providers comprises data required for scheduling reservations of human and non-human resources, and wherein the data required for scheduling reservations of human and non-human resources comprises human resource records, resource records for non-human resources that can be reserved by customers, resource groups that organize resources for presentation in various scheduling interfaces, availability periods that define days and hours a particular resource is available for reservation, and/or reservation records.

10. The system of claim 1, wherein the data center further comprises an HTTP web server,
wherein the HTTP web server receives reservation instructions from customers using the web-based customer calendar or the mobile scheduling interface or from employees using the web-based in-store calendar;
wherein the received instructions have a payload;
wherein the HTTP web server brokers the payload of the received instructions to XML Web Services;
wherein the XML Web Services invoke SQL stored procedures to get data from and put data to the data store;
wherein XML Web Services format and send data back to the HTTP server; and
wherein the HTTP server packages the formatted data and sends it back to the customer or employee requesting the reservation.

11. The system of claim 10, wherein the instructions are in the form of Simple Object Access Protocol messages.

12. The system of claim 1, wherein the hosted line-of-business software application comprises a web-based service-management form, and wherein a service provider employee uses the service management form to define services to be offered by that service provider's human resources.

13. The system of claim 12, wherein the service management form comprises a means for specifying a status of active or inactive for a particular service record, a field for specifying the average duration of the service, and/or a field for recording a description of the service, and a save button to commit any changes made to the service record to the service provider chain database.

14. The system of claim 13, wherein the duration of the service specified in the service management form determines the amount of time a reservation for that service will block out on the web-based in-store calendar and the web-based customer calendar.

15. The system of claim 1, wherein the hosted line-of-business software application comprises web-based human and non-human resource management forms.

16. The system of claim 15, wherein the human resource management form comprises a sub-tab that allows a human resource record to be associated with one or more services defined in the service management form.

17. The system of claim 1, wherein the hosted line-of-business software application comprises a calendar management form, and wherein the calendar management form comprises a list of resources to be presented to individuals who are making reservations with human and non-human resources using the web-based in-store calendar or the web-based customer calendar.

18. The system of claim 17, wherein the calendar management form allows for the creation of resource groups for organizing the list of resources to be presented to individuals who are making reservations.

19. The system of claim 17, wherein the calendar management form comprises a slot length field that allows a service provider to specify schedulable intervals that will appear on the web-based in-store calendar and the web-based customer calendar.

20. The system of claim 17, wherein the calendar management form comprises a default reservation duration field that allows a service provider to specify a default length of a reservation for a non-human resource.

21. The system of claim 1, wherein a service provider uses the hosted line-of-business application to configure services and resources to be offered by that service provider and to organize the resources into groups.

22. The system of claim 1, wherein the hosted line-of-business software application is web-based software that comprises point of sale, inventory management, reporting, customer marketing, and payroll functionality.

23. The system of claim 1, wherein a customer-created reservation is insured to be valid by pre-qualifying available reservation options and presenting them in real-time to the customer.

24. The system of claim 1, wherein resource availability data is presented to the service provider employee via the web-based in-store calendar and to the customer via the web-based customer calendar and/or the mobile scheduling interface, and wherein both the employee and the customer are presented with the same resource availability data in real-time, thereby eliminating double-booking and delayed notification of reservation acceptance or denial.

25. The system of claim 1, wherein the web-based customer calendar is specific to a service provider or service provider location.

26. The system of claim 1, wherein the web-based in-store calendar shows a schedule for all resources in a resource group.

27. The system of claim 1, wherein service provider employees use the web-based in-store calendar to define availability periods for each resource for which a reservation may be made.

28. The system of claim 1, wherein the in-store calendar comprises functionality for searching for customer records and specifying reservation details.

29. The system of claim 1, wherein after a service provider employee saves a reservation in the web-based in-store calendar, the service provider chain database is updated in real-time with information about the reservation.

30. The system of claim 1, wherein the web-based customer calendar shows a daily schedule for all resources in a resource group selected from a drop-down list of resource groups.

31. The system of claim 1, wherein the web-based customer calendar displays a weekly schedule for a selected resource.

32. The system of claim 1, wherein the web-based customer calendar displays a weekly schedule for all resources in a selected resource group.

33. The system of claim 1, wherein the web-based customer calendar displays a monthly schedule for a selected resource.

34. The system of claim 1, wherein to make a reservation a customer selects an empty time slot in a pre-defined availability period.

35. The system of claim 1, wherein after a customer saves a reservation in the web-based customer calendar, the service provider chain database is updated in real-time with information about the reservation.

36. The system of claim 1, wherein when the customer or service provider employee selects a start time for a new reservation, the services offered by the selected human resource are filtered based on the start time selected by the customer or employee, the availability information for the resource, and if there is a subsequent reservation with a start time, the start time of the subsequent reservation for the resource.

37. The system of claim 1, wherein the mobile scheduling interface allows customers to select from a plurality of service providers to make a resource reservation.

38. The system of claim 1, wherein the mobile scheduling interface provides the ability to search for service providers by zip code, global positioning system coordinates, city, county, area code, and/or service provider category.

39. The system of claim 1, wherein the mobile scheduling interface comprises a mobile scheduling wizard, and wherein the mobile scheduling wizard comprises a list of service providers with which the customer has previously made reservations.

40. The system of claim 39, wherein when a customer selects a service provider, information concerning the selection is sent to an XML Web Service and date information is requested, and wherein the requested date information is displayed on a subsequent page of the mobile scheduling wizard.

41. The system of claim 40, wherein the mobile scheduling wizard displays a list of dates on which the selected service provider is willing to accept reservations self-scheduled by customers, and wherein the customer selects a date for a new reservation.

42. The system of claim 41, wherein the mobile scheduling wizard displays a list of resource groups defined by the selected service provider and available on the date selected by the customer, and wherein the customer selects a resource group.

43. The system of claim 42, wherein the mobile scheduling wizard displays a list of resources within the resource group selected by the customer, and the customer selects a resource.

44. The system of claim 43, wherein if the selected resource is a human resource, the mobile scheduling wizard displays a list of services associated with the selected human resource, and the customer selects a service.

45. The system of claim 43 or 44, wherein the mobile scheduling wizard displays a list of dates and times that are currently available for reservation based on the selections previously made by the customer.

46. The system of claim 45, wherein when the customer selects a date and time for a new reservation, the reservation is booked, and the service provider chain database is updated in real-time with information about the new reservation.

47. The system of claim 1, wherein no distinction is made between reservations made by a customer and reservations made by a service provider employee.

48. The system of claim 1, wherein the system concurrently provides stand-alone and aggregate resource scheduling functionality.

49. A method for real-time resource scheduling comprising:
(a) providing a hosted line-of-business software application for service providers operating in various industry verticals;
(b) providing a central data center;
(c) providing an in-store web-based calendar for service provider employees;
(d) providing a web-based calendar for service provider customers; and
(e) providing a mobile customer scheduling interface;
wherein the central data center comprises a data store;
wherein the data store comprises a master database and a plurality of service provider chain databases;
wherein the master database contains metadata of all service provider chain databases housed in the data store;
wherein the master database contains user accounts for customers who make reservations with any of the service providers;
wherein each service provider has a service provider chain database that is specific to that service provider;
wherein customer profile information is stored in the service provider chain databases;
wherein a customer's user account is associated with customer profile data for that customer in multiple, autonomous service provider chain databases;
wherein no data is shared between service providers;
wherein each service provider creates and maintains all resource scheduling information for its own human and nonhuman resources;
wherein the resource scheduling information comprises availability information;
wherein a customer uses either the web-based customer calendar or the mobile scheduling interface to make a reservation for a resource;
wherein when the customer accesses the web-based calendar or the mobile scheduling interface to make a reservation, only the time slots for which the resource is available are made available to the customer for a new reservation;
wherein a service provider employee uses the web-based in-store calendar to make a reservation for a resource on behalf of a customer;
wherein when a reservation is made by a customer or a service provider employee, the reservation information is transmitted in real-time to the service provider chain database; and
wherein instances of the web-based in-store calendar and the web-based customer calendar poll at configurable intervals for updates to reservation information and are updated with new reservation information during each subsequent polling cycle.

50. The method of claim 49, wherein the configurable interval is several seconds.

51. The method of claim 49, wherein the web-based customer calendar shows resources only for a single service provider.

52. The method of claim 49, wherein the web-based customer calendar displays existing reservations in a different color to signify that one or more time slots are not available for scheduling.

53. The method of claim 49, wherein the web-based in-store calendar displays existing reservations in a different color to signify that one or more time slots are not available for scheduling.

54. The method of claim 49, wherein the service provider chain database comprises a customer table, and wherein when a customer signs in using an existing user account or creates a new user account, the system inserts a new record in the customer table of the service provider chain database if this is the first time the customer has signed in to a location in that service provider's network of locations.

55. The method of claim 49, wherein each service provider chain database contains data specific to a particular service provider or chain of related service providers.

56. The method of claim 55, wherein the data specific to a particular service provider or chain of related service providers comprises inventory records, service records, membership/package records, sales history, purchase orders, client/customer profiles, email and text messages sent for purposes of marketing or reminding customers of upcoming reservations, and/or employee user accounts.

57. The method of claim 55, wherein the data specific to a particular service provider or chain of related service providers comprises data required for scheduling reservations of human and non-human resources, and wherein the data required for scheduling reservations of human and non-human resources comprises human resource records, resource records for non-human resources that can be reserved by customers, resource groups that organize resources for presentation in various scheduling interfaces, availability periods that define days and hours a particular resource is available for reservation, and/or reservation records.

58. The method of claim 49, wherein the data center further comprises an HTTP web server,
wherein the HTTP web server receives reservation instructions from customers using the web-based customer calendar or the mobile scheduling interface or from employees using the web-based in-store calendar;
wherein the received instructions have a payload;
wherein the HTTP web server brokers the payload of the received instructions to XML Web Services;
wherein the XML Web Services invoke SQL stored procedures to get data from and put data to the data store;
wherein XML Web Services format and send data back to the HTTP server; and
wherein the HTTP server packages the formatted data and sends it back to the customer or employee requesting the reservation.

59. The method of claim 58, wherein the instructions are in the form of Simple Object Access Protocol messages.

60. The method of claim 49, wherein the hosted line-of-business software application comprises a web-based service management form, and wherein a service provider employee uses the service management form to define services to be offered by that service provider's human resources.

61. The method of claim 60, wherein the service management form comprises a means for specifying a status of active or inactive for a particular service record, a field for specifying the average duration of the service, and/or a field for recording a description of the service, and a save button to commit any changes made to the service record to the service provider chain database.

62. The method of claim 61, wherein the duration of the service specified in the service management form determines the amount of time a reservation for that service will block out on the web-based in-store calendar and the web-based customer calendar.

63. The method of claim 49, wherein the hosted line-of-business software application comprises web-based human and non-human resource management forms.

64. The method of claim 63, wherein the human resource management form comprises a sub-tab that allows a human resource record to be associated with one or more services defined in the service management form.

65. The method of claim 49, wherein the hosted line-of-business software application comprises a calendar management form, and wherein the calendar management form comprises a list of resources to be presented to individuals who are making reservations with human and non-human resources using the web-based in-store calendar or the web-based customer calendar.

66. The method of claim 65, wherein the calendar management form allows for the creation of resource groups for organizing the list of resources to be presented to individuals who are making reservations.

67. The method of claim 65, wherein the calendar management form comprises a slot length field that allows a service provider to specify schedulable intervals that will appear on the web-based in-store calendar and the web-based customer calendar.

68. The method of claim 65, wherein the calendar management form comprises a default reservation duration field that allows a service provider to specify a default length of a reservation for a non-human resource.

69. The method of claim 49, wherein a service provider uses the hosted line-of-business application to configure services and resources to be offered by that service provider and to organize the resources into groups.

70. The method of claim 49, wherein the hosted line-of-business software application is web-based software that comprises point of sale, inventory management, reporting, customer marketing, and payroll functionality.

71. The method of claim 49, wherein a customer-created reservation is insured to be valid by pre-qualifying available reservation options and presenting them in real-time to the customer.

72. The method of claim 49, wherein resource availability data is presented to the service provider employee via the web-based in-store calendar and to the customer via the web-based customer calendar and/or the mobile scheduling interface, and wherein both the employee and the customer are presented with the same resource availability data in real-time, thereby eliminating double-booking and delayed notification of reservation acceptance or denial.

73. The method of claim 49, wherein the web-based customer calendar is specific to a service provider or service provider location.

74. The method of claim 49, wherein the web-based in-store calendar shows a schedule for all resources in a resource group.

75. The method of claim 49, wherein service provider employees use the web-based in-store calendar to define availability periods for each resource for which a reservation may be made.

76. The method of claim 49, wherein the in-store calendar comprises functionality for searching for customer records and specifying reservation details.

77. The method of claim 49, wherein after a service provider employee saves a reservation in the web-based in-store calendar, the service provider chain database is updated in real-time with information about the reservation.

78. The method of claim 49, wherein the web-based customer calendar shows a daily schedule for all resources in a resource group selected from a drop-down list of resource groups.

79. The method of claim 49, wherein the web-based customer calendar displays a weekly schedule for a selected resource.

80. The method of claim 49, wherein the web-based customer calendar displays a weekly schedule for all resources in a selected resource group.

81. The method of claim 49, wherein the web-based customer calendar displays a monthly schedule for a selected resource.

82. The method of claim 49, wherein to make a reservation a customer selects an empty time slot in a pre-defined availability period.

83. The method of claim 49, wherein after a customer saves a reservation in the web-based customer calendar, the service provider chain database is updated in real-time with information about the reservation.

84. The method of claim 49, wherein when the customer or service provider employee selects a start time for a new reservation, the services offered by the selected human resource are filtered based on the start time selected by the customer or employee, the availability information for the resource, and if there is a subsequent reservation with a start time, the start time of the subsequent reservation for the resource.

85. The method of claim 49, wherein the mobile scheduling interface allows customers to select from a plurality of service providers to make a resource reservation.

86. The method of claim 49, wherein the mobile scheduling interface provides the ability to search for service providers by zip code, global positioning system coordinates, city, county, area code, and/or service provider category.

87. The method of claim 49, wherein the mobile scheduling interface comprises a mobile scheduling wizard, and wherein the mobile scheduling wizard comprises a list of service providers with which the customer has previously made reservations.

88. The method of claim 87, wherein when a customer selects a service provider, information concerning the selection is sent to an XML Web Service and date information is requested, and wherein the requested date information is displayed on a subsequent page of the mobile scheduling wizard.

89. The method of claim 88, wherein the mobile scheduling wizard displays a list of dates on which the selected service provider is willing to accept reservations self-scheduled by customers, and wherein the customer selects a date for a new reservation.

90. The method of claim 89, wherein the mobile scheduling wizard displays a list of resource groups defined by the selected service provider and available on the date selected by the customer, and wherein the customer selects a resource group.

91. The method of claim 90, wherein the mobile scheduling wizard displays a list of resources within the resource group selected by the customer, and the customer selects a resource.

92. The method of claim 91, wherein if the selected resource is a human resource, the mobile scheduling wizard displays a list of services associated with the selected human resource, and the customer selects a service.

93. The method of claim 91 or 92, wherein the mobile scheduling wizard displays a list of dates and times that are currently available for reservation based on the selections previously made by the customer.

94. The method of claim 93, wherein when the customer selects a date and time for a new reservation, the reservation is booked, and the service provider chain database is updated in real-time with information about the new reservation.

95. The method of claim 49, wherein no distinction is made between reservations made by a customer and reservations made by a service provider employee.

96. The method of claim 49, wherein the system concurrently provides stand-alone and aggregate resource scheduling functionality.
